(19) United States
(12) Patent Application Publication
(10) Pub. No.: US 2004/0190905 A1
(43) Pub. Date: Sep. 30, 2004

(54) Optical transmission system and apparatus

(76) Inventor: Shinya Kano, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/783,882

(22) Filed: Feb. 19, 2004

(30) Foreign Application Priority Data
Mar. 27, 2003 (JP) 2003-088140

(51) Int. Cl. H04B 10/00

(52) U.S. Cl. 398/141

(57) ABSTRACT

An optical transmission system is disclosed that has a simple configuration and is capable of searching for and setting port numbers between two optical transmission apparatuses opposite to each other. The optical transmission apparatus on the transmitting side includes a control unit, an optical switch module, and an electrical-optical converter. The control unit includes a table management unit, a test status message receiver, a test message transmitter, a port number correspondence table, and a transmission port controller. The optical transmission apparatus on the receiving side includes a control unit, an optical switch module, and an optical-electrical converter. The control unit includes a table management unit, a test status message transmitter, a test message receiver, a port number correspondence table, and a reception port controller.

### BACKGROUND OF THE INVENTION

1. Field of the Invention

The present invention relates to an optical transmission system and an optical transmission apparatus.

2. Description of the Related Art

An optical cross-connect device (OXC), or another optical transmission device that switches transmission paths of received optical signals, is connected with optical transmission apparatuses opposite to each other through a number of data links. Here, for example, data links means fibers or wavelengths multiplexed by a wavelength division multiplexer (WDM). Because of the usage of the wavelength division multiplexer, the optical transmission apparatuses opposite to each other may be connected by a greater number of data links, but more time is required for setting connection relations of the data links between the optical transmission apparatuses in each of the apparatuses. For this reason, the IETF (Internet Engineering Task Force) drafted a protocol (LMP: Link Management Protocol) for automatically searching for the connection relations of the data links between the optical transmission apparatuses and setting the connection relations in each of the optical transmission apparatuses. Details of LMP are described in “Internet Draft ‘Link Management Protocol (LMP): draft IETF ccamp LMP 07. txt’ Standards Track”, Network Working Group, J. Lang Editor, November 2002.

FIG. 1 is a block diagram showing a configuration of an optical transmission system in the related art in compliance with LMP.

As shown in FIG. 1, LMP is executed between two optical transmission apparatuses.

The optical transmission apparatus 10 on the test signal transmitting end includes a control unit 11, an optical switch module 12, and transponders 17 through 19.

The control unit 11 includes a table management unit 13, a test status message receiver 14, a test message transmitter 15, and a port number correspondence table 16.

The optical switch module 12 is an optical switching circuit for switching transmission paths of received optical signals which carry user data.

The table management unit 13 manages the port number correspondence table 16. Stored in the port number correspondence table 16 are the transmission port number of the optical transmission apparatus 10 for sending a test message and the reception port number of the optical transmission apparatus 20 opposite to the optical transmission apparatus 10 for receiving the test message.

Further, the transmission port number in the optical transmission apparatus 10 for sending the test message and the reception port number in the opposite optical transmission apparatus 20 for receiving the test message are included in a test status message sent from a test status message transmitter 24 (described below) of the optical transmission apparatus 20.

The test status message receiver 14 receives the test status message sent from the test status message transmitter 24 of the optical transmission apparatus 20.

The test status message includes the transmission port number in the optical transmission apparatus 10 for sending the test message and the reception port number in the opposite optical transmission apparatus 20 for receiving the test message.

The test message transmitter 15 transmits the test message including the transmission port number for sending the test message to the opposite optical transmission apparatus 20 via the transponders 17 through 19 through the data link.

The port number correspondence table 16 includes a data base for storing transmission port numbers in the optical transmission apparatus 10 and the corresponding reception port numbers in the opposite optical transmission apparatus 20.

FIG. 2A is a block diagram showing a configuration of a transponder in the optical transmission apparatus 10 in the related art.

Each of the transponders 17 through 19, as shown in FIG. 2A, is an optical-electrical-optical converter including an optical-electrical converter 1 and an electrical-optical converter 2, and performs error checking, shaping of optical signals carrying the user data, and wavelength conversion for the optical signals. Further, the transponders 17 through 19 superpose the test message on the data link for transmitting user data, and supply the test message from the test message transmitter 15 to the electrical-optical converter 2.

In addition, a circuit may be provided, between the optical-electrical converter 1 and the electrical-optical converter 2 when it is necessary to perform error checking and shaping of the optical signals.

The optical transmission apparatus 20 on the test signal receiving end includes a control unit 21, an optical switch module 22, and transponders 27 through 29.

The control unit 21 includes a table management unit 23, the test status message transmitter 24, a test message receiver 25, and a port number correspondence table 26.

The optical switch module 22 is an optical switching circuit for switching transmission paths of received optical signals which carry user data.

The table management unit 23 manages the port number correspondence table 26. In the port number correspondence table 26 are stored the transmission port number in the optical transmission apparatus 10 opposite to the optical transmission apparatus 20 for sending the test message and the reception port number of the optical transmission apparatus 20 for receiving the test message.

The transmission port number in the opposite optical transmission apparatus 10 for sending the test message is included in the received test message.

The test status message transmitter 24 sends the test status message including the transmission port number in the optical transmission apparatus 10 on the end of transmitting the test message and the reception port number in the optical transmission apparatus 20 on the end of receiving the test message to the opposite optical transmission apparatus 10 through a control channel.

The test message receiver 25 receives the test message via the transponders 27 through 29 through the data link.

The port number correspondence table 26 includes a data base for storing transmission port numbers in the opposite optical transmission apparatus 10 and the corresponding reception port numbers in the optical transmission apparatus 20.

FIG. 2B is a block diagram showing a configuration of a transponder in the optical transmission apparatus 20 in the related art.

Each of the transponders 27 through 29, as shown in FIG. 2B, is an optical-electrical-optical converter including an optical-electrical converter 3 and an electrical-optical converter 4, and performs error checking, shaping of the optical signals, and wavelength conversion of the optical signals. Further, each of the transponders 27 through 29 converts the test message transmitted on the data link to electrical signals, and supplies the test message in the form of electrical signals to the test message receiver 25. In addition, a circuit may be provided between the optical-electrical converter 3 and the electrical-optical converter 4 when it is necessary to perform error checking and shaping of the optical signals.

FIG. 3 is a flowchart showing the operation of the optical transmission system in the related art in compliance with LMP.

First, the transmission port #1 of the optical transmission apparatus 10 and the reception port of the opposite optical transmission apparatus 20 are searched for. This search is performed following the procedure described below.

In step S11, the test message transmitter 15 of the optical transmission apparatus 10 transmits the test message from the transponder 17 via the transmission port #1 to the data link. When sending the test message, the test message transmitter 15 adds the port number (#1) in this transmission to the test message in advance.

In step S12, the test message receiver 25 of the optical transmission apparatus 20 receives the test message from the data link via the port #1 and the transponder 27. Then, the test message receiver 25 notifies the table management unit 23 of the received test message and the receiving port number for receiving the test message.

In step S13, the table management unit 23 of the optical transmission apparatus 20 stores the transmission port number (#1) in the optical transmission apparatus 10 for sending the test message and the reception port number (#1) of the optical transmission apparatus 20 for receiving the test message in the port number correspondence table 26, while maintaining the transmission port number and the reception port number in correspondence with each other. Then, the table management unit 23 notifies the test status message transmitter 24 of the stored data.

In step S14, the test status message transmitter 24 of the optical transmission apparatus 20 sends the test status message including the transmission port number (#1) in the opposite optical transmission apparatus 10 for transmitting the test message and the reception port number (#1) in the optical transmission apparatus 20 for receiving the test message to the opposite optical transmission apparatus 10 through the control channel.

In step S15, the test status message receiver 14 of the optical transmission apparatus 10 receives the test status message sent from the test status message transmitter 24 of the optical transmission apparatus 20 through the control channel, which includes the transmission port number (#1) in the optical transmission apparatus 10 for sending the test message and the reception port number (#1) in the opposite optical transmission apparatus 20 for receiving the test message. Then, the test status message is transmitted to the table management unit 13.

In step S16, the table management unit 13 of the optical transmission apparatus 10 stores the transmission port number (#1) in the optical transmission apparatus 10 for sending the test message and the reception port number (#1) of the optical transmission apparatus 20 for receiving the test message, which are included in the received test status message, in the port number correspondence table 16, while maintaining the transmission port number and the reception port number in correspondence with each other.

In step S17, step S11 through S16 are repeated for all other ports.

FIG. 4A is a block diagram of the configuration of the optical transmission system in the related art for explaining the operation shown in FIG. 3 using the transmission port #1 and the reception port #1.

FIGS. 4B and 4C are block diagrams of the configuration of the optical transmission system in the related art for explaining the operation of the system when using the transmission port #2 and port #3, respectively.

The operations shown in FIG. 4B and FIG. 4C are the same as that in FIG. 4A, involving searching for the corresponding relation between the transmission port #2 and port #3 in the optical transmission apparatus 10 and the reception ports in the opposite optical transmission apparatus 20, and storing them in the port number correspondence tables of the respective transmission apparatuses.

Following the above procedure, the connection relations of the data links can be set in each of the opposite optical transmission apparatuses by automatically searching for the connection relations of the data links between the opposite optical transmission apparatuses without manual operations. As a result, the reception port #1, port #3 and port #2 of the optical transmission apparatus 20 are stored in the port number correspondence table of the optical transmission apparatus 20 in correspondence with the transmission port #1, port #2, and port #3, respectively, of the optical transmission apparatus 10.

However, in LMP, as described above, in order to search for the connection relations of the data links between the opposite optical transmission apparatuses, it is necessary to transmit the test message on the data link for transmitting user data. For this purpose, it is required that the upstream optical transmission apparatus send the test message to the data link, and the downstream optical transmission apparatus receive the test message from the data link. In other words, the upstream optical transmission apparatus needs to convert the optical signals on the data link to electrical signals, and convert the electrical signals back to optical signals after writing the test message. Similarly, the downstream optical transmission apparatus also needs to convert the optical signals on the data link to electrical signals, and convert the electrical signals back to optical signals after extracting the test message.

The above operations of converting optical signals to electrical signals and vice versa, and writing and extracting the test message, require a system of large size.

### SUMMARY OF THE INVENTION

Accordingly, it is an object of the present invention to solve one or more of the problems of the related art.

It is a more specific object of the present invention to provide an optical transmission system and an optical transmission apparatus having a simple configuration capable of searching for and setting port numbers between two opposite optical transmission apparatuses.

According to a first aspect of the present invention, there is provided an optical transmission system including a first optical transmission apparatus having a first optical switch, and a second optical transmission apparatus having a second optical switch. The optical transmission system is capable of setting a connection relation between the first optical transmission apparatus and the second optical transmission apparatus. The first optical transmission apparatus includes a first transmission unit provided on an input side of the first optical switch configured to transmit a first control message, and a transmission port control unit configured to control the first optical switch. The first control message includes a transmission port number of a transmission port for transmitting the first control message, and the transmission port control unit controls the first optical switch so that the first control message is transmitted through different transmission ports sequentially.

Preferably, the second optical transmission apparatus includes a first reception unit provided on an output side of the second optical switch configured to receive the first control message; and a reception port control unit configured to control the second optical switch. The reception port control unit controls the second optical switch so that the first control message is received by the first reception unit through different reception ports sequentially.

Preferably, the transmission port control unit controls the first optical switch so that the first control message is transmitted through different transmission ports sequentially and periodically.

Preferably, after receiving the first control message, the first reception unit controls the reception port control unit so as to receive the first control message next time through a reception port having a reception port number next to a present reception port number.

Preferably, the first optical transmission apparatus further comprises a second reception unit configured to receive a second control message including the transmission port number and a reception port number of the second optical transmission apparatus for receiving the first control message. After the second reception unit receives the second control message, the first transmission unit transmits a control message as the first control message from a transmission port having a transmission port number next to the transmission port number included in the second control message, the next transmission port number being included in the control message transmitted by the first transmission unit as the first control message.

Further, the second optical transmission apparatus further comprises a second transmission unit configured to transmit the second control message, and the reception port control unit controls, the second optical switch so that the first control message is received through different reception ports sequentially and periodically.

According to a second aspect of the present invention, there is provided an optical transmission system including a first optical transmission apparatus having a first optical switch; and a second optical transmission apparatus having a second optical switch. The optical transmission system is capable of setting a connection relation between the first optical transmission apparatus and the second optical transmission apparatus. The first optical transmission apparatus includes an optical signal transmission unit provided on an input side of the first optical switch configured to transmit an optical signal; a first transmission unit configured to transmit a first control message; and a transmission port control unit configured to control the first optical switch. The first control message includes a transmission port number of a transmission port for transmitting the optical signal; and the transmission port control unit controls the first optical switch so that the optical signal is transmitted through different transmission ports sequentially and periodically.

Preferably, the second optical transmission apparatus includes an optical signal reception unit provided on an output side of the second optical switch configured to receive the optical signal; and a reception port control unit configured to control the second optical switch so that the optical signal is received by the optical signal reception unit through different reception ports sequentially. After receiving the optical signal, the optical signal reception unit controls the reception port control unit so as to receive the optical signal next time through a reception port having a reception port number next to a present reception port number.

According to a third aspect of the present invention, there is provided an optical transmission system including a first optical transmission apparatus having a first optical switch; and a second optical transmission apparatus having a second optical switch. The optical transmission system is capable of setting a connection relation between the first optical transmission apparatus and the second optical transmission apparatus. The first optical transmission apparatus includes an optical signal transmission unit provided on an input side of the first optical switch configured to transmit an optical signal; a transmission port control unit configured to control the first optical switch; a first transmission unit configured to transmit a first control message including a transmission port number of a transmission port for transmitting the optical signal; and a first reception unit configured to receive a second control message including the transmission port number and a reception port number of a reception port of the second optical transmission apparatus for receiving the optical signal. After the first reception unit receives the second control message, the transmission port control unit controls the first optical switch so that the optical signal is transmitted through a transmission port having a transmission port number next to the transmission port number included in the second control message.

Preferably, the second optical transmission apparatus includes an optical signal reception unit provided on an output side of the second optical switch configured to receive the optical signal; a reception port control unit configured to control the second optical switch so that-the optical signal is received by the optical signal reception unit through different reception ports sequentially; a second transmission unit configured to transmit the second control message; and a second reception unit configured to receive the first control message. The optical signal reception unit controls the reception port control unit so as to receive the optical signal through different reception ports sequentially and periodically.

According to a fourth aspect of the present invention, there is provided an optical transmission system including a first optical transmission apparatus having a first optical switch; and a second optical transmission apparatus having a second optical switch. The optical transmission system is capable of setting a connection relation between the first optical transmission apparatus and the second optical transmission apparatus. The first optical transmission apparatus includes a test signal transmission unit provided on an input side of the first optical switch configured to transmit a test signal; and a transmission unit configured to transmit a control message including a transmission port number of a transmission port for transmitting the test signal. The test signal transmission unit transmits the test signal through different transmission ports sequentially, separated by a predetermined time period.

Preferably, the second optical transmission apparatus includes a test signal reception unit provided on an output side of the second optical switch configured to receive the test signal to monitor a reception state; and a reception unit configured to receive the control message.

According to a fifth aspect of the present invention, there is provided an optical transmission system including a first optical transmission apparatus having a first optical switch; and a second optical transmission apparatus having a second optical switch. The optical transmission system is capable of setting a connection relation between the first optical transmission apparatus and the second optical transmission apparatus. The first optical transmission apparatus includes a test signal transmission unit provided on an input side of the first optical switch configured to transmit a test signal; a first transmission unit configured to transmit a first control message including a transmission port number of a transmission port for transmitting the test signal; and a first reception unit configured to receive a second control message including the transmission port number and a reception port number of a reception port of the second optical transmission apparatus for receiving the test signal. After the first reception unit receives the second control message, the test signal transmission unit transmits the test signal through a transmission port having a transmission port number next to the transmission port number included in the second control message.

Preferably, the second optical transmission apparatus includes a test signal reception unit provided on an output side of the second optical switch configured to receive the test signal to monitor a reception state; a second transmission unit configured to transmit the second control message; and a second reception unit configured to receive the first control message.

As an embodiment, the second transmission unit transmits a plurality of control messages simultaneously.

As an embodiment, the optical transmission system may further include a control message reception waiting timer that starts to count the time when the first control message is received, and terminates after a predetermined time period. When the control message reception waiting timer terminates, the reception port control unit controls the second optical switch so that the first control message is received through a different reception port.

As an embodiment, the second optical transmission apparatus includes an optical signal reception unit provided on an output side of the second optical switch configured to receive the optical signal; a reception port control unit configured to control the second optical switch so that the optical signal is received by the optical signal reception unit through different reception ports sequentially; and a control message reception waiting timer that starts to count the time when the first control message is received, and terminates after a predetermined time period. When the control message reception waiting timer terminates, the reception port control unit controls the second optical switch so that the first control message is received through a different reception port.

As an embodiment, the first optical transmission apparatus includes a first reception unit configured to receive a second control message including the transmission port number and a reception port number of a reception port of the second optical transmission apparatus for receiving the first control message; and a control message reception waiting timer that starts to count the time when the second control message is received, and terminates after a predetermined time period. When the control message reception waiting timer terminates, the transmission port control unit controls the first optical switch so that the first control message is transmitted through a next transmission port, the next transmission port number being included in said transmitted first control message.

According to a sixth aspect of the present invention, there is provided an optical transmission system including a first optical transmission apparatus having a first optical switch; and a second optical transmission apparatus having a second optical switch, capable of setting a connection relation between the first optical transmission apparatus and the second optical transmission apparatus. The first optical transmission apparatus includes an optical signal transmission unit provided on an input side of the first optical switch configured to transmit an optical signal; a transmission port control unit configured to control the first optical switch; a first transmission unit configured to transmit a first control message including a transmission port number of a transmission port for transmitting the optical signal; a first reception unit configured to receive a second control message including the transmission port number and a reception port number of a reception port of the second optical transmission apparatus for receiving the optical signal; and a control message reception waiting timer that starts to count the time when the second control message is received, and terminates after a predetermined time period. When the control message reception waiting timer terminates, the transmission port control unit controls the first optical switch so that the first control message is transmitted from a next transmission port.

According to a seventh aspect of the present invention, there is provided an optical transmission apparatus having an optical switch capable of setting a connection relation with another optical transmission apparatus opposite thereto, including a transmission unit provided on an input side of the optical switch configured to transmit a first control message; and a transmission port control unit configured to control the optical switch. The first control message includes a transmission port number of a transmission port for transmitting the first control message; and the transmission port control unit controls the optical switch so that the first control message is transmitted through different transmission ports sequentially.

As an embodiment, the transmission port control unit controls the optical switch so that the first control message is transmitted through different transmission ports sequentially and periodically.

As an embodiment, the optical transmission apparatus further comprises a reception unit configured to receive a second control message including the transmission port number and a reception port number of the opposite optical transmission apparatus for receiving the first control message. After the reception unit receives the second control message, the transmission unit transmits a control message as the first control message from a transmission port having a transmission port number next to the transmission port number included in the second control message, the next transmission port number being included in the transmitted control message.

According to an eighth aspect of the present invention, there is provided an optical transmission apparatus having an optical switch capable of setting a connection relation with another optical transmission apparatus opposite thereto, including a reception unit provided on an output side of the optical switch configured to receive a control message; and a reception port control unit configured to control the optical switch. The reception port control unit controls the optical switch so that the control message is received through different reception ports sequentially.

As an embodiment, after receiving the control message, the reception unit controls the reception port control unit so as to receive the control message next time through a reception port having a reception port number next to a present reception port number.

Preferably, the reception port control unit controls the optical switch so that the control message is received through different reception ports sequentially and periodically.

According to a ninth aspect of the present invention, there is provided an optical transmission apparatus having an optical switch capable of setting a connection relation with another optical transmission apparatus opposite thereto, including an optical signal transmission unit provided on an input side of the optical switch configured to transmit an optical signal; a transmission unit configured to transmit a control message; and a transmission port control unit configured to control the optical switch. The transmission port control unit controls the optical switch so that the optical signal is transmitted through different transmission ports sequentially and periodically.

According to a 10th aspect of the present invention, there is provided an optical transmission apparatus having an optical switch capable of setting a connection relation with another optical transmission apparatus opposite thereto, including an optical signal transmission unit provided on an input side of the optical switch configured to transmit an optical signal; a transmission port control unit configured to control the optical switch; a transmission unit configured to transmit a first control message including a transmission port number of a transmission port for transmitting the optical signal; and-a reception unit configured to receive a second control message including the transmission port number and a reception port number of a reception port of the opposite optical transmission apparatus for receiving the optical signal. After the reception unit receives the second control message, the transmission port control unit controls the optical switch so that the optical signal is transmitted through a transmission port having a transmission port number next to the transmission port number included in the second control message.

According to an 11th aspect of the present invention, there is provided an optical transmission apparatus having an optical switch capable of setting a connection relation with another optical transmission apparatus opposite thereto, including a test signal transmission unit provided on an input side of the optical switch configured to transmit a test signal; a transmission unit configured to transmit a control message including a transmission port number of a transmission port for transmitting the test signal. The test signal transmission unit transmits the test signal through different transmission ports sequentially, separated by a predetermined time period.

According to a 12th aspect of the present invention, there is provided an optical transmission apparatus having an optical switch capable of setting a connection relation with another optical transmission apparatus opposite thereto, including a test signal transmission unit provided on an input side of the optical switch configured to transmit a test signal; a transmission unit configured to transmit a first control message including a transmission port number of a transmission port for transmitting the test signal; and a reception unit configured to receive a second control message including the transmission port number and, a reception port number of a reception port of the opposite optical transmission apparatus for receiving the test signal. After the reception unit receives the second control-message, the test signal transmission unit transmits the test signal through a transmission port having a transmission port number next to the transmission port number included in the second control message.

According to the present invention, by transmitting a control message including the transmission port number of the first optical transmission apparatus for transmitting a test message, an optical signal, or a test signal to the second transmission apparatus on the opposite side, it is possible to provide an optical transmission system and an optical transmission apparatus capable of searching for and setting port numbers between two opposite optical transmission apparatuses with a simple configuration. The control message may be a Begin-Verify message different from the above test message, an optical signal, or a test signal.

In addition, because the transmitter for transmitting the test message, optical signal, or test signal is provided on the input side of an optical switch, and the receiver for receiving the test message, optical signal, or test signal is provided on the output side of the optical switch, it is not necessary to provide a transmitter and a receiver for each output port any longer as is done in the related art, and it is possible to greatly reduce the size of the circuit and the cost.

These and other objects, features, and advantages of the present invention will become more apparent from the following detailed description of the preferred embodiments given with reference to the accompanying drawings.

### BRIEF DESCRIPTION OF THE DRAWINGS

FIG. 1 is a block diagram showing a configuration of an optical transmission system in the related art;

FIGS. 2A and 2B are block diagrams for explaining transponders;

FIG. 3 is a flowchart showing the operation of the optical transmission system in the related art;

FIGS. 4A through 4C are block diagrams for explaining the operation of the optical transmission system in the related art;

FIG. 5 is a block diagram showing a configuration of a first port number searching system according to the present invention;

FIG. 6 is a block diagram showing a configuration of a second port number searching system according to the present invention;

FIG. 7 is a block diagram showing a configuration of a third port number searching system according to the present invention;

FIG. 8 is a block diagram showing a configuration of a fourth port number searching system according to the present invention;

FIG. 9 is a diagram showing an example of a test status message;

FIG. 10 is a diagram showing an example of a test message;

FIG. 11 is a diagram showing an example of a Begin-Verify message;

FIGS. 12A through 12D are block diagrams showing an example of operations of the port number searching system shown in FIG. 5 according to a first embodiment;

FIGS. 13A through 13D are block diagrams showing another example of operations of the port number searching system shown in FIG. 5 according to a second embodiment;

FIGS. 14A through 14D are block diagrams showing an example of operations of the port number searching system shown in FIG. 6 according to a third embodiment;

FIGS. 15A through 15D are block diagrams showing another example of operations of the port number searching system shown in FIG. 6 according to a fourth embodiment; and

FIGS. 16A through 16C are block diagrams showing an example of operations of the port number searching system shown in FIG. 7 according to a fifth embodiment.

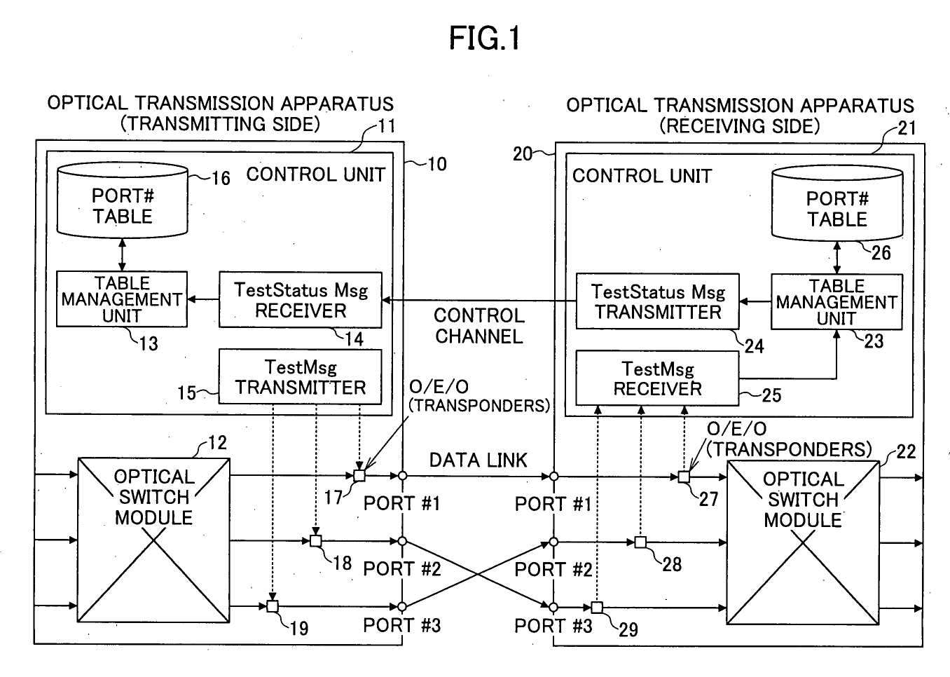

### DESCRIPTION OF THE PREFERRED EMBODIMENTS

Below, preferred embodiments of the present invention are explained with reference to the accompanying drawings.

First, a number of preferred configurations of the optical transmission system according to the present invention are described prior to detailed explanations of the operations thereof.

### First Optical Transmission System

FIG. 5 is a block diagram showing a configuration of a first port number searching system according to the present invention, including an optical transmission apparatus 30 on the transmitting end and an optical transmission apparatus 40 on the receiving end opposite to the optical transmission apparatus 30.

[Apparatus for Transmitting Test Message]

The optical transmission apparatus 30 that transmits a test signal includes a control unit 31, an optical switch module 32, and an electrical-optical converter (E/O) 39.

The control unit 31 includes a table management unit 33, a test status message receiver 34, a test message transmitter 35, a port number correspondence table 36, and a transmission port controller 38.

The optical switch module 32 is an optical switching circuit for switching transmission paths of the received optical signals which carry user data.

The table management unit 33 manages the port number correspondence table 36. Stored in the port number correspondence table 36 are the transmission port numbers in the optical transmission apparatus 30 for sending the test message and the reception port numbers in the optical transmission apparatus 40 opposite to the optical transmission apparatus 30 for receiving the test message, wherein the transmission port numbers are managed in correspondence with the reception port numbers.

The table management unit 33 informs the test message transmitter 35 of the port number for transmitting the test message, notifies the test message transmitter 35 of the fact that the optical transmission apparatus 40 has received a test message transmitted from the optical transmission apparatus 30, or directs the test message transmitter 35 to change the transmission port.

The transmission port number in the optical transmission apparatus 30 for sending the test message and the reception port number of the optical transmission apparatus 40 for receiving the test message are included in a test status message transmitted from the optical transmission apparatus 40.

The test status message receiver 34 receives the test status message including the transmission port number in the optical transmission apparatus 30 and the reception port number in the optical transmission apparatus 40.

The test status message is transmitted by a test status message transmitter 44 of the optical transmission apparatus 40 through a control channel.

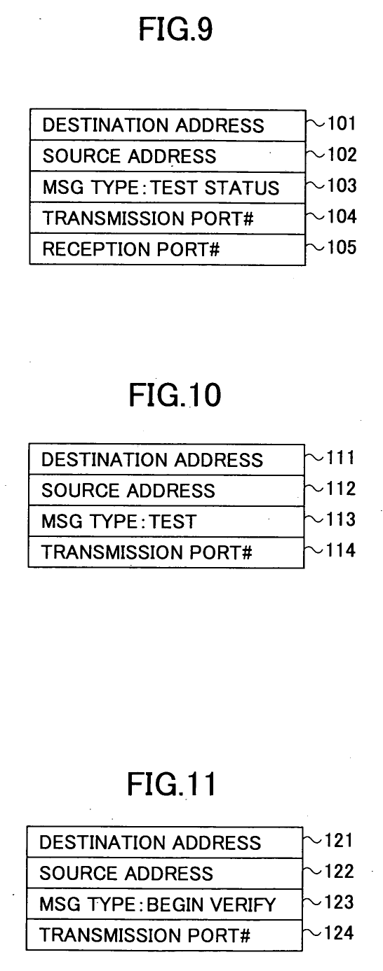

FIG. 9 is a diagram showing an example of the test status message.

As shown in FIG. 9, the test status message includes a destination address 101, a source address 102, a message (MSG) type indicator 103, a transmission port number 104, and a reception port number 105.

The destination address 101 is the address of the optical transmission apparatus to which the test status message is to be sent. The source address 102 is the address of the optical transmission apparatus from which the test status message is sent.

The MSG type indicator 103 indicates the type of the message, and in the test status message, its value is “TEST STATUS”.

The transmission port number 104 is the number of the transmission port for transmitting the test message. This number is the same as the transmission port number included in the test message and in the Begin-Verify message.

The reception port number 105 is the number of the reception port for receiving the test message.

The test message transmitter 35 transmits the transmission port number for transmitting the test message to the transmission port controller 38. In addition, the test message transmitter 35 generates the test message including the transmission port number for transmitting the test message, and transmits the generated test message to the optical switch module 32 through the electrical-optical converter 39.

FIG. 10 is a diagram showing an example of the test message.

As shown in FIG. 10, the test message includes a destination address 111, a source address 112, a message (MSG) type indicator 113, and a transmission port number 114.

The destination address 111 is the address of the optical transmission apparatus to which the test message is to be sent. The source address 112 is the address of the optical transmission apparatus from which the test message is sent.

The message type indicator 113 indicates the type of the message, and its value is “TEST” in the test message.

The transmission port number 114 is the number of the transmission port for transmitting the test message.

The electrical-optical converter 39 is installed on the input side of the optical switch module 32, and outputs the test message from the test message transmitter 35 to the data link for transmitting user data. The electrical-optical converter 39 may be formed from light emission diodes, which are turned ON or OFF according to the signals from the test message transmitter 35.

The port number correspondence table 36 includes a data base for storing transmission port numbers in the optical transmission apparatus 30 and the corresponding reception port numbers in the opposite optical transmission apparatus 40. The port number correspondence table 36 is managed by the table management unit 33.

The transmission port controller 38 switches the output of the optical switch module 32 according to the directions from the test message transmitter 35, and switches the transmission port for transmitting the test message.

[Apparatus for Receiving Test Message]

The optical transmission apparatus 40 that receives the test signal includes a control unit 41, an optical switch module 42, and an optical-electrical converter (O/E) 49.

The control unit 41 includes a table management unit 43, the test status message transmitter 44, a test message receiver 45, a port number correspondence table 46, and a reception port controller 48.

The optical switch module 42 is an optical switching circuit for switching transmission paths of the received optical signals which carry user data.

The table management unit 43 manages the port number correspondence table 46. Stored in the port number correspondence table 46 are the transmission port numbers in the optical transmission apparatus 30 for sending the test message and the reception port numbers in the optical transmission apparatus 40 for receiving the test message, wherein the transmission port numbers are managed in correspondence with the reception port numbers. The transmission port number in the optical transmission apparatus 30 for sending the test message is included in the received test message.

The test status message transmitter 44 transmits the test status message to the optical transmission apparatus 30 through the control channel. The test status message includes the transmission port number in the optical transmission apparatus 30 for transmitting the test message and the reception port number in the optical transmission apparatus 40 for receiving the test message.

The test message receiver 45 receives the test message transmitted from the data link through the optical-electrical converter 49, notifies the table management unit 43 of the reception port number for receiving the test message, and controls the reception port controller 48 when necessary.

The port number correspondence table 46 includes a data base for storing transmission port numbers in the optical transmission apparatus 30 and the corresponding reception port numbers in the opposite optical transmission apparatus 40. The port number correspondence table 46 is managed by the table management unit 43.

The reception port controller 48 switches the output of the optical switch module 42 at predetermined time intervals, or according to the directions from the test message receiver 45, and switches the reception port for receiving the test message.

The optical-electrical converter 49 is installed on the output side of the optical switch module 42; it receives the test message from the data link, and outputs the test message to the test message transmitter 45.

According to the present optical transmission system, because of usage of the electrical-optical converter 39 and the optical-electrical converter 49, instead of the transponders 17-19 and 27-29 used in the related art, which are optical-electrical-optical converters, the configurations of the two optical transmission apparatuses opposite to each other become simple due to the absence of the optical-electrical portion and the electrical-optical portion in the converters 39 and 49, respectively. In the related art, a transponder is provided for each transmission port and each reception port, and therefore a number of the transponders equal to the number of the transmission or reception ports are needed in each optical transmission apparatus. In the present configuration, because the electrical-optical converter 39 is installed on the input side of the optical switch module 32, and the optical-electrical converter 49 is installed on the output side of the optical switch module 42, at least one electrical-optical converter and one optical-electrical converter are sufficient for performing searching for and setting of the connection relations of the data links between the opposite optical transmission apparatuses as specified in LMP.

### Second Optical Transmission System

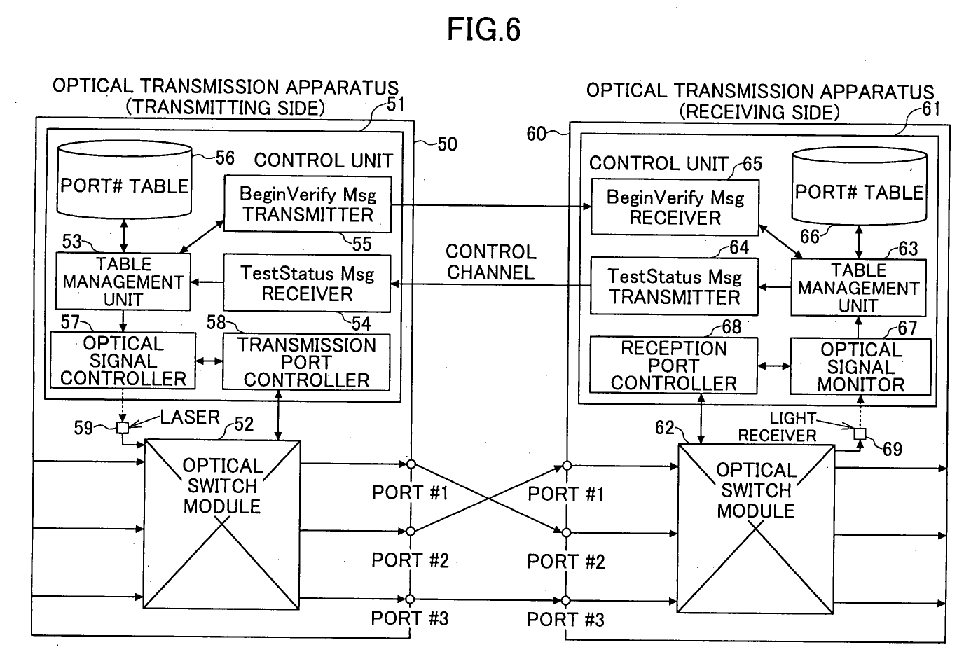

FIG. 6 is a block diagram showing a configuration of a second port number searching system according to the present invention, including an optical transmission apparatus 50 on the transmitting end and an optical transmission apparatus 60 on the receiving end opposite to the optical transmission apparatus 50.

[Apparatus for Transmitting Test Message]

The optical transmission apparatus 50 for transmitting a test signal includes a control unit 51, an optical switch module 52, and a laser 59.

The control unit 51 includes a table management unit 53, a test status message receiver 54, a Begin-Verify message transmitter 55, a port number correspondence table 56, an optical signal controller 57, and a transmission port controller 58.

The optical switch module 52, the port number correspondence table 56, and the transmission port controller 58 in the optical transmission apparatus 50 may have the same configurations as the optical switch module 32, the port number correspondence table 36, and the transmission port controller 38 in the optical transmission apparatus 30 (shown in FIG. 5), respectively, and explanations of these elements are omitted.

The table management unit 53 manages the port number correspondence table 56. Stored in the port number correspondence table 56 are the transmission port numbers in the optical transmission apparatus 50 for sending the optical signals emitted from the laser 59, and the reception port numbers in the optical transmission apparatus 60 opposite to the optical transmission apparatus 50 for receiving the optical signals, wherein the transmission port numbers are managed in correspondence with the reception port numbers.

The table management unit 53 informs the transmission port controller 58 of the port number for transmitting the optical signals emitted from the laser 59, and notifies the Begin-Verify message transmitter 55 of the port number for transmitting the optical signals.

The test status message receiver 54 receives the test status message including the reception port number in the optical transmission apparatus 60. The test status message is transmitted by a test status message transmitter 64 of the optical transmission apparatus 60 through a control channel. The same as the system shown in FIG. 5, here, the test status message includes the transmission port number in the optical transmission apparatus 50 for transmitting the optical signals and the reception port number in the optical transmission apparatus 60 for receiving the optical signals.

The Begin-Verify message transmitter 55 transmits a Begin-Verify message including the transmission port number for transmitting the optical signals emitted from the laser 59 to the optical transmission apparatus 60 through the control channel.

FIG. 11 is a diagram showing an example of the Begin-Verify message.

As shown in FIG. 11, the Begin-Verify message includes a destination address 121, a source address 122, a message (MSG) type indicator 123, and a transmission port number 124.

The destination address 121 is the address of the optical transmission apparatus to which the Begin-Verify message is to be sent. The source address 122 is the address of the optical transmission apparatus from which the Begin-Verify message is sent.

The message type indicator 123 indicates the type of the message, and its value is “Begin-Verify” in the Begin-Verify message.

The transmission port number 124 is the number of the transmission port for transmitting the Begin-Verify message.

The optical signal controller 57 accepts the directions from the table management unit 53, and controls the laser 59 to emit light. Further, the optical signal controller 57 notifies the transmission port controller 58 of the port number in the optical transmission apparatus 50 for transmitting the optical signals emitted from the laser 59, and controls the laser 59 to emit light.

The optical signal controller 57 may not only control the laser 59 to emit light, but also control turning the laser 59 ON or OFF, and as a result, the emitted optical signals are used for searching for and setting of port numbers between two opposite optical transmission apparatuses.

The transmission port controller 58 switches the output of the optical switch module 52 according to the directions from the optical signal controller 57, and switches the transmission port for transmitting the test message.

The laser 59 emits light while being controlled by the optical signal controller 57. The light from the laser 59 is directed to the optical switch module 52. It should be noted that an electrical-optical converter may be used instead of the laser 59, as is done in the system shown in FIG. 5.

[Apparatus for Receiving Test Message]

The optical transmission apparatus 60 that receives the test signal includes a control unit 61, an optical switch module 62, and a light receiver 69.

The control unit 61 includes a table management unit 63, the test status message transmitter 64, a Begin-Verify message receiver 65, a port number correspondence table 66, an optical signal monitor 67, and a reception port controller 68.

The optical switch module 62, the port number correspondence table 66, and the reception port controller 68 in the optical transmission apparatus 60 may have the same configurations as the optical switch module 42, the port number correspondence table 46, and the transmission port controller 48 in the optical transmission apparatus 40 (shown in FIG. 5), respectively, and explanations of these elements are omitted.

The table management unit 63 manages the port number correspondence table 66. Stored in the port number correspondence table 66 are the transmission port numbers in the optical transmission apparatus 50 for sending the optical signals, which are included in the received Begin-Verify message, and the reception port numbers in the optical transmission apparatus 60 for receiving the optical signals, wherein the transmission port numbers are managed in correspondence with the reception port numbers.

The test status message transmitter 64 transmits the test status message to the optical transmission apparatus 50 through the control channel. The test status message includes the reception port number in the optical transmission apparatus 60 for receiving the optical signals.

Alternatively, for the system shown in FIG. 5, the test status message may include both the transmission port number in the optical transmission apparatus 50 for transmitting the optical signals and the reception port number in the optical transmission apparatus 60 for receiving the optical signal.

The Begin-Verify message receiver 65 of the optical transmission apparatus 60 receives the Begin-Verify message from the Begin-Verify message transmitter 55. The Begin-Verify message includes the transmission port number in the optical transmission apparatus 50 for transmitting the optical signals. The Begin-Verify message is transmitted through the control channel.

The reception port controller 68 switches the output of the optical switch module 62 at predetermined time intervals, or according to the directions from the optical signal monitor 67, and switches the reception port for receiving the optical signals from the laser 59 of the optical transmission apparatus 50.

The light receiver 69 is installed on the output side of the optical switch module 62; it receives the light from the laser 59 of the optical transmission apparatus 50 transmitted through the data link, and outputs the light to the optical light monitor 67.

According to the present optical transmission system, by providing the Begin-Verify message transmitter 55 in the optical transmission apparatus 50 and the Begin-Verify message receiver 65 in the optical transmission apparatus 60 to communicate the transmission port number in the optical transmission apparatus 50 for transmitting the optical signals, it is not necessary to superpose the transmission port number for transmitting the optical signals on the optical signals.

Therefore, instead of the transponders used in the related art, which are optical-electrical-optical converters, the configuration becomes simple due to usage of the laser and the light receiver. Because it is not necessary to superpose the transmission port number for transmitting the optical signals on the optical signals, the circuits for processing the optical signals, including the transmission system and the reception system, become simple.

### Third Optical Transmission System

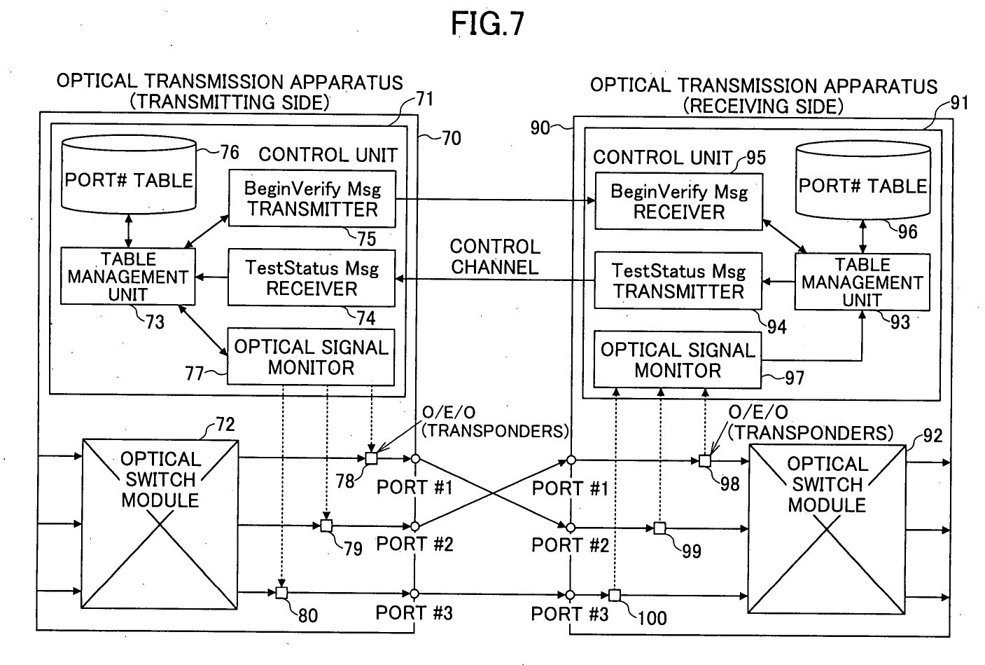

FIG. 7 is a block diagram showing a configuration of a third port number searching system according to the present invention, including an optical transmission apparatus 70 on the transmitting end and an optical transmission apparatus 90 on the receiving end opposite to the optical transmission apparatus 70.

[Apparatus for Transmitting Test Message]

The optical transmission apparatus 70 for transmitting a test signal includes a control unit 71, an optical switch module 72, and transponders 78 through 80.

The control unit 71 includes a table management unit 73, a test status message receiver 74, a Begin-Verify message transmitter 75, a port number correspondence table 76, and an optical signal controller 77.

The optical switch module 72, the table management unit 73, the test status message receiver 74, the Begin-Verify message transmitter 75, and the port number correspondence table 76 in the optical transmission apparatus 70 may have the same configurations as the optical switch module 52, the table management unit 53, the test status message receiver 54, the Begin-Verify message transmitter 55, and the port number correspondence table 56 in the optical transmission apparatus 50, respectively, as shown in FIG. 6, and explanations of these elements are omitted.

The optical signal controller 77 controls the transponders 78 through 80 so that one of the transponders 78 through 80, which are provided on the output side of the optical switch module 72, outputs optical signals.

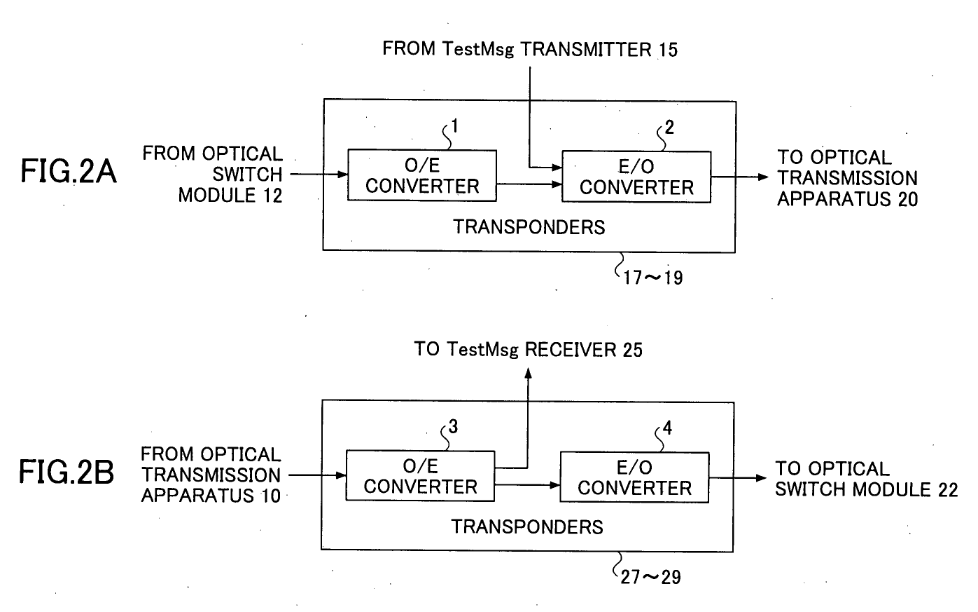

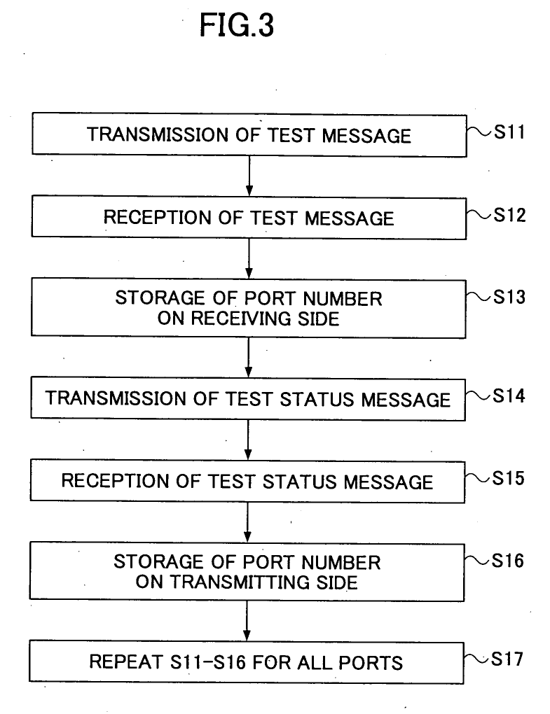

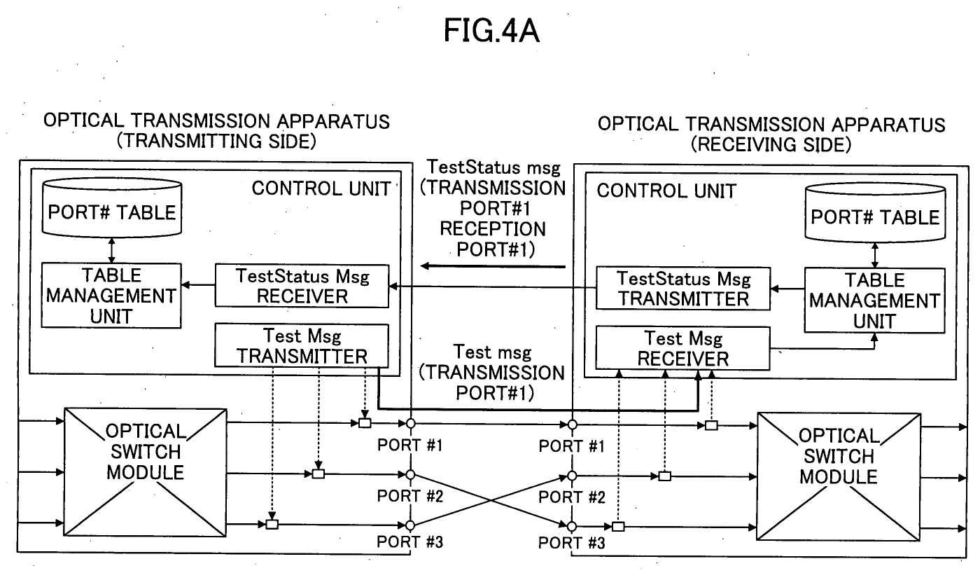

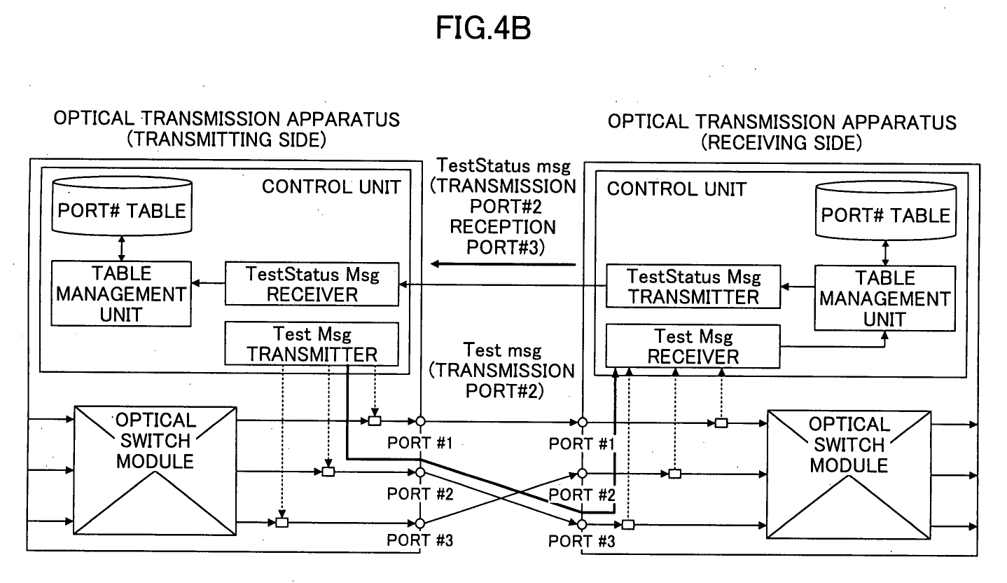

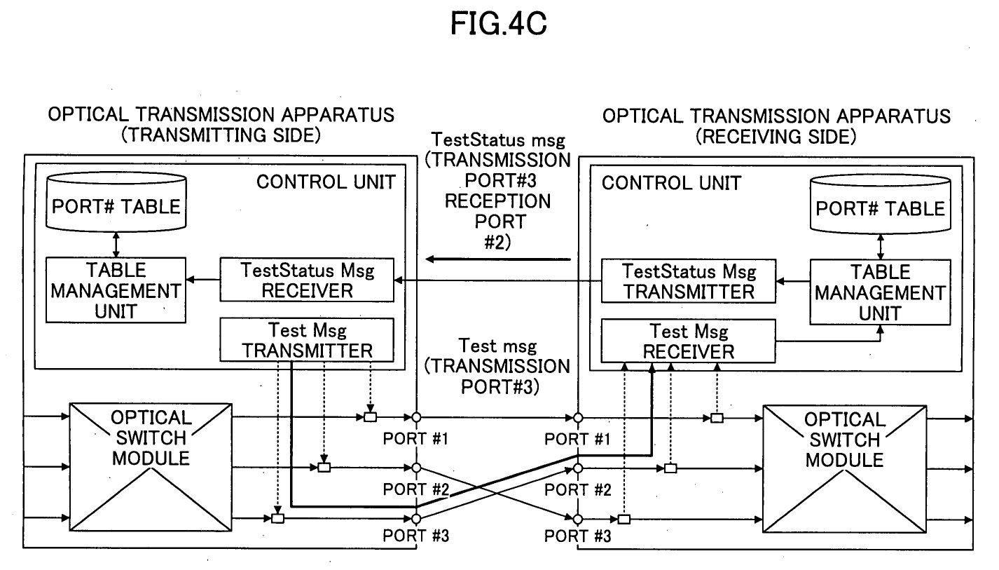

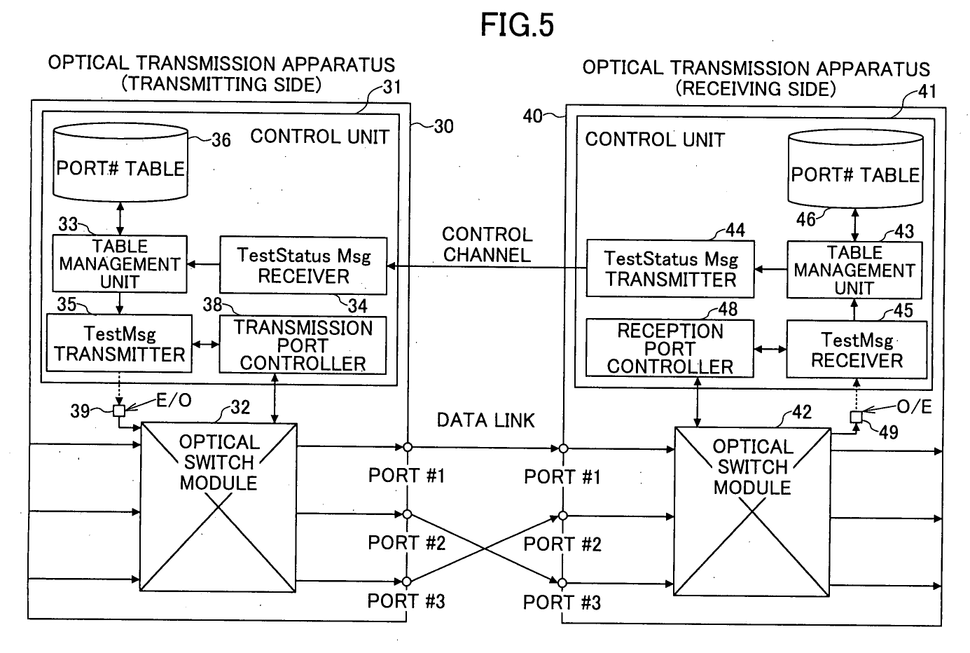

Each of the transponders 78 through 80, as shown in FIG. 2A, is an optical-electrical-optical converter including an optical-electrical converter and an electrical-optical converter, and performs error checking, shaping of the optical signals, and wavelength conversion of the optical signals. Further, the transponders 78 through 80 are controlled based on the control signals from the optical signal controller 77 to output the optical signals through a certain port.

[Apparatus for Receiving Test Message]

The optical transmission apparatus 90 that receives the test signal includes a control unit 91, an optical switch module 92, and transponders (optical-electrical-optical converters) 98 through 100.

The control unit 91 includes a table management unit 93, a test status message transmitter 94, a Begin-Verify message receiver 95, a port number correspondence table 96, and an optical signal monitor 97.

The optical switch module 92, the table management unit 93, the test status message transmitter 94, the Begin-Verify message receiver 95, and the port number correspondence table 96 in the optical transmission apparatus 90 may have the same configurations as the optical switch module 62, the table management unit 63, the test status message transmitter 64, the Begin-Verify message receiver 65, and the port number correspondence table 66 in the optical transmission apparatus 60, respectively, as shown in FIG. 6, and explanations of these elements are omitted.

The optical signal monitor 97 monitors the light receiving condition of the transponders 98 through 100, which are provided on the input side of the optical switch module 92, and communicates the monitoring results to the table management unit 93.

Each of the transponders 98 through 100, as shown in FIG. 2B, is an optical-electrical-optical converter including an optical-electrical converter and an electrical-optical converter, and performs error checking, shaping of the optical signals, and wavelength conversion of the optical signals. Further, the transponders 98 through 100 output the optical signals from the optical-electrical converter to the optical signal monitor 97.

The third port number searching system is applicable when optical-electrical-optical converters are required to perform error checking, shaping of the optical signals, and wavelength conversion of the optical signals between two opposite optical transmission apparatuses.

According to the present optical transmission system, by providing the Begin-Verify message transmitter 75 in the optical transmission apparatus 70 and the Begin-Verify message receiver 95 in the optical transmission apparatus 90 to communicate the transmission port number in the optical transmission apparatus 70 for transmitting the optical signals, it is not necessary to superpose the transmission port number for transmitting the optical signals on the optical signals. Therefore, the circuits for processing the optical signals, including the transmission system and the reception system, become simple.

### Fourth Optical Transmission System

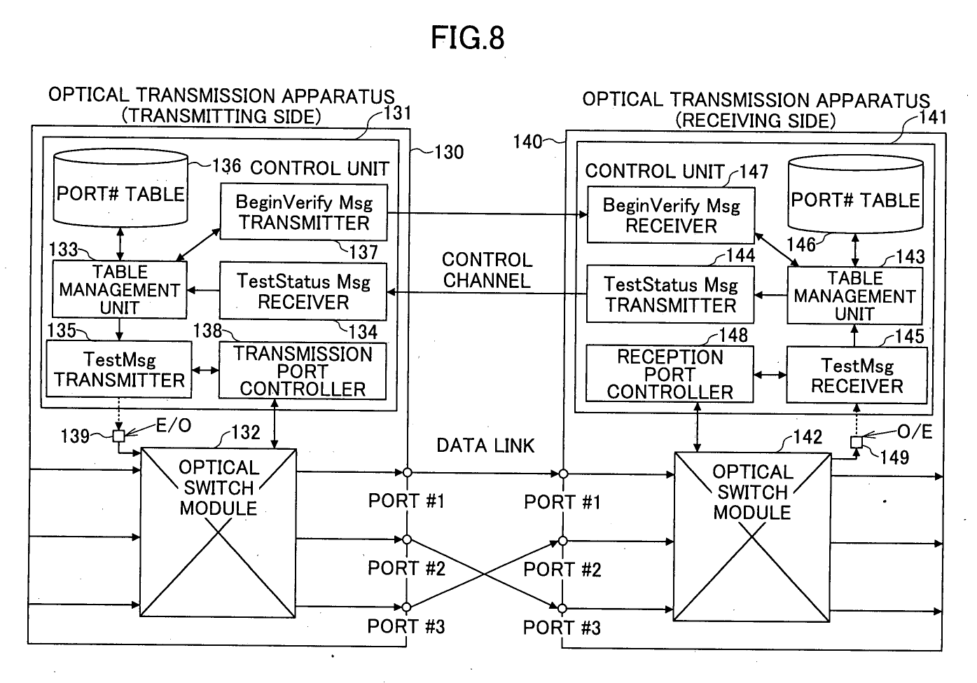

FIG. 8 is a block diagram showing a configuration of a fourth port number searching system according to the present invention, including an optical transmission apparatus 130 on the transmitting end and an optical transmission apparatus 140 on the receiving end opposite to the optical transmission apparatus 130.

[Apparatus for Transmitting Test Message]The optical transmission apparatus 130 that transmits a test signal includes a control unit 131, an optical switch module 132, and an electrical-optical converter (E/O) 139.

The control unit 131 includes a table management unit 133, a test status message receiver 134, a test message transmitter 135, a port number correspondence table 136, a Begin-Verify message transmitter 137 and a transmission port controller 138.

The optical switch module 132, the test message transmitter 135, the port number correspondence table 136, the transmission port controller 138, and the electrical-optical converter 139 in the optical transmission apparatus 130 may have the same configurations as the optical switch module 32, the test message transmitter 35, the port number correspondence table 36, the transmission port controller 38, and the electrical-optical converter 39 in the optical transmission apparatus 30, respectively, as shown in FIG. 5, and the table management unit 133, the test status message receiver 134, and the Begin-Verify message receiver 137 in the optical transmission apparatus 130 may have the same configurations as the table management unit 53, the test status message receiver 54, and the Begin-Verify message receiver 57 in the optical transmission apparatus 50, respectively, as shown in FIG. 6, and explanations of all these elements are omitted.

[Apparatus for Receiving Test Message]

The optical transmission apparatus 140 that receives the test signal includes a control unit 141, an optical switch module 142, and an optical-electrical converter (O/E) 149.

The control unit 141 includes a table management unit 143, a test status message transmitter 144, a test message receiver 145, a port number correspondence table 146, a Begin-Verify message receiver 147, and a reception port controller 148.

The optical switch module 142, the test message receiver 145, the port number correspondence table 146, the reception port controller 148, and the optical-electrical converter (O/E) 149 in the optical transmission apparatus 140 may have the same configurations as the optical switch module 42, the test message receiver 45, the port number correspondence table 46, the reception port controller 48, and the optical-electrical converter (O/E) 49 in the optical transmission apparatus 40, respectively, as shown in FIG. 5, and the table management unit 143, the test status message transmitter 144, and the Begin-Verify message receiver 147 in the optical transmission apparatus 140 may have the same configurations as the table management unit 63, the test status message transmitter 64, and the Begin-Verify message receiver 65 in the optical transmission apparatus 60, respectively, as shown in FIG. 6, and explanations of all these elements are omitted.

The fourth port number searching system is a combination of the systems in FIG. 5 and FIG. 6, and is able to be used to replace the system in FIG. 5 or the system FIG. 6 when necessary.

### First Embodiment

The present embodiment relates to an example of operations of the port number searching system shown in FIG. 5 for searching for and setting the data link connection relation between the optical transmission apparatuses 30 and 40.

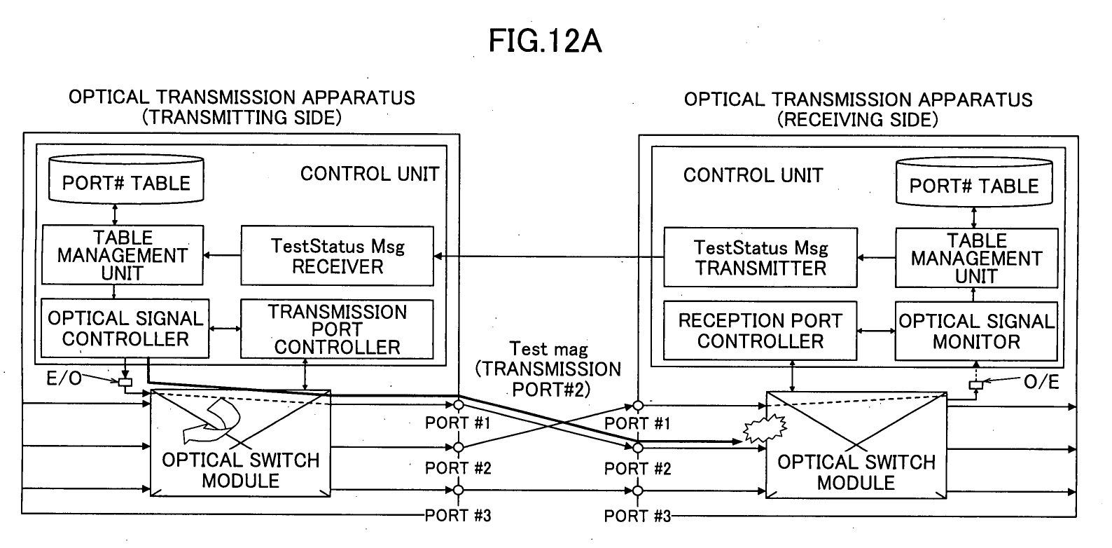

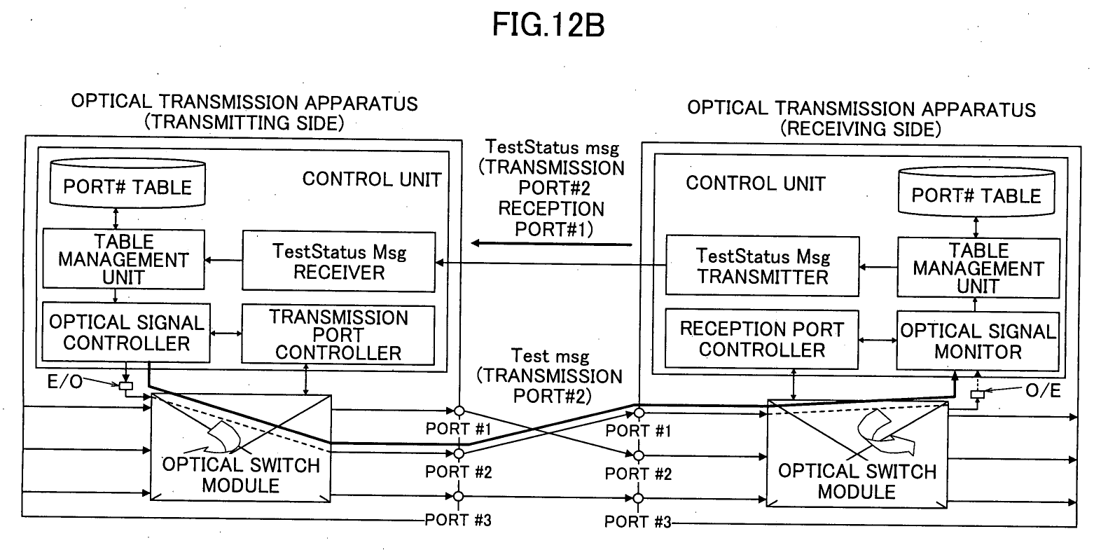

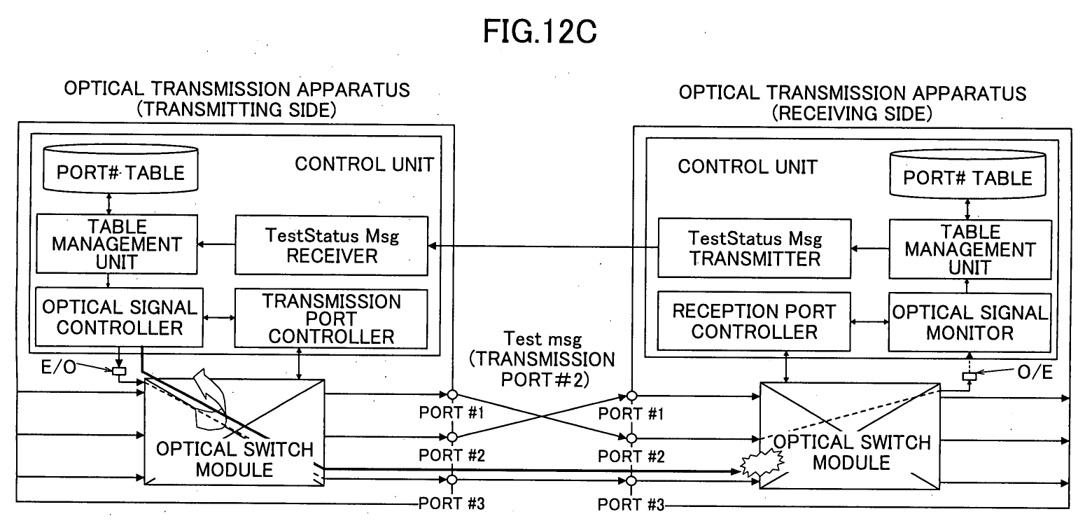

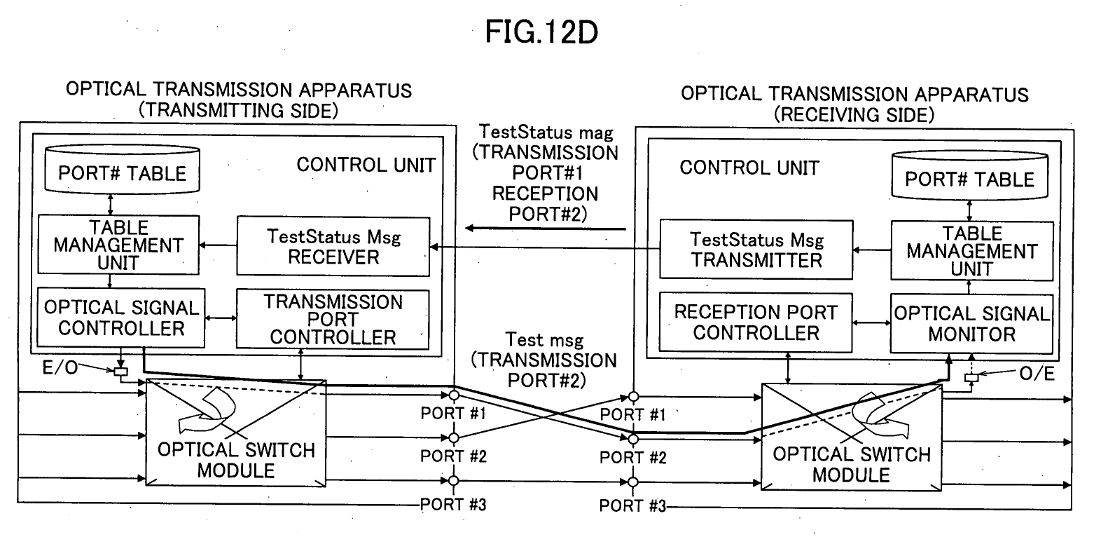

In this embodiment and those following, operation of the optical transmission apparatus 30 and operation of the optical transmission apparatus 40 are independent from each other, although operations of the two apparatuses are shown in connection with each other in, for example, FIGS. 12A through 12D, for the purpose of illustration.

### Operation of Apparatus for Transmitting Test Message

(1) <<Transmission of Test Message>>

Step 1:

The test message transmitter 35 notifies the transmission port controller 38 of the specified transmission port number for transmitting a test message.

After receiving the specified transmission port number, the transmission port controller 38 sets the optical switch module 32 so that the optical signals from the electrical-optical converter (E/O) 39 are output from the specified transmission port. For example, transmission port #1 is specified at the beginning.

The test message transmitter 35 periodically switches the specified transmission port. Alternatively, the test message transmitter 35 receives a notification from the table management unit 33 of the fact that the optical transmission apparatus 40 has received a test message, and then switches the specified transmission port.

If necessary, the test message transmitter 35 receives a port number for transmitting the test message or a direction for switching the transmission port from the table management unit 33.

Step 2:

The test message transmitter 35 supplies the test message to the electrical-optical converter 39, and the electrical-optical converter 39 outputs optical signals of the test message. The test message optical signals are sent to the optical switch module 32. Under control of the transmission port controller 38, the optical signals are transmitted from the specified transmission port by the test message transmitter 35 to the data link. The test message transmitter 35 inserts the number of the transmission port in the test message in advance.

Step 3:

The test message transmitter 35 transmits the test message through the available transmission ports sequentially from the smallest port number to the largest one, and back to the smallest port number. Specifically, the test message transmitter 35 transmits the test message sequentially through the transmission port #1, then the transmission port #2, then the transmission port #3, and then back to the transmission port #1, and so on.

(2) <<Reception of Test Status Message>>

Step 1:

The test status message receiver 34 receives the test status message including the transmission port number in the optical transmission apparatus 30 and the reception port number in the optical transmission apparatus 40. The test status message is transmitted through the control channel. The received test status message is sent to the table management unit 33.

Step 2:

The table management unit 33 stores the transmission port number in the optical transmission apparatus 30 for sending the test message and the corresponding reception port numbers in the optical transmission apparatus 40 for receiving the test message, which are included in the received test status message, in the port number correspondence table 36.

### Operation of Apparatus for Receiving Test Message

(3) <<Reception of Test Message>>

Step 1:

The test message receiver 45 notifies the reception port controller 48 of the reception port number for receiving the test message. Based on the notification from the test message receiver 45, the reception port controller 48 sets the optical switch module 42. For example, the reception port #1 is set at the beginning.

In this state, if the test message from the optical transmission apparatus 30 is supplied to the specified reception port, the test message receiver 45 receives the test message from the optical transmission apparatus 30 through the optical-electrical converter 49. If the test message from the optical transmission apparatus 30 is not supplied to the specified reception port, the optical transmission apparatus 40 waits for signal input.

Below, it is assumed that optical signals are supplied to the specified reception port.

Step 2:

When the test message receiver 45 receives the test message transmitted through the data link via the optical-electrical converter 49, the test message receiver 45 notifies the table management unit 43 of the test message and the reception port number for receiving the test message.

Step 3:

The table management unit 43 stores the transmission port number in the optical transmission apparatus 30 for sending the test message and the reception port number in the optical transmission apparatus 40 for receiving the test message, which are included in the received test message, in the port number correspondence table 46. The table management unit 43 notifies the test status message transmitter 44 of the stored data.

(4) <<Transmission of Test Status Message>>

Step 1:

The test status message transmitter 44 generates the test status message which includes the transmission port number in the optical transmission apparatus 30 for transmitting the test message and the reception port number in the optical transmission apparatus 40 for receiving the test message, and transmits the test status message to the optical transmission apparatus 30 through the control channel.

Step 2:

After the operations in STEP 2 of section (3) as described above, the test message receiver 45 receives the test message through the available reception ports sequentially from the smallest port number to the largest one, and then back to the smallest port number again. Specifically, the test message receiver 45 receives the test message sequentially through the reception port #1, then the reception port #2, then the reception port #3, and then back to the reception port #1, and so on.

FIGS. 12A through 12D are block diagrams showing the operation of the port number searching system shown in FIG. 5 according to the present embodiment.

At first, the test message is transmitted through the transmission port #1 of the optical transmission apparatus 30.

In the optical transmission apparatus 40, it is set that the test message is to be received at the reception port #1. Because the port #1 of the optical transmission apparatus 30 and the port #1 of the optical transmission apparatus 40 are not connected, as shown in FIG. 12A, the optical transmission apparatus 40 fails in receiving the test message.

Then, after a predetermined time period, the test message transmitter 35 requests the transmission port controller 38 to change the transmission port number for transmitting the test message.

After receiving the request, the transmission port controller 38 sets the optical switch module 32 so that the optical signals from the electrical-optical converter 39 are output from the transmission port #2.

Because the port #2 of the optical transmission apparatus 30 and the port #1 of the optical transmission apparatus 40 are connected, as shown in FIG. 12B, the optical transmission apparatus 40 succeeds in receiving the test message.

After that, in the optical transmission apparatus 40, the operations in STEP 2 and STEP 3 in section (3) and STEP 1 and STEP 2 in section (4) as described above are performed, and as a result, in the optical transmission apparatus 40, it is set that the test message is to be received at the port #2.

On the side of the optical transmission apparatus 30, subsequent to the port #2, it is set that the test message is transmitted at the port number #3. However, because the port #3 of the optical transmission apparatus 30 and the port #2 of the optical transmission apparatus 40 are not connected, as shown in FIG. 12C, the optical transmission apparatus 40 fails in receiving the test message.

Then, after a predetermined time period, the test message transmitter 35 requests the transmission port controller 38 to change the transmission port number for transmitting the test message.

Upon receiving the request, the transmission port controller 38 sets the-optical switch module 32 so that the optical signals from the electrical-optical converter 39 are output from the transmission port #1.

Because the port #1 of the optical transmission apparatus 30 and the port #2 of the optical transmission apparatus 40 are connected, as shown in FIG. 12D, the optical transmission apparatus 40 succeeds in receiving the test message.

Consequently, corresponding to port #1, port #2, and port #3 of the optical transmission apparatus 30, port #2, port #1, and port #3, respectively, of the optical transmission apparatus 40 are stored in the port number correspondence table 36 and the port number correspondence table 46.

In this way, despite a simple configuration, the optical transmission system according to the present invention is capable of automatically searching for and setting port numbers between two opposite optical transmission apparatuses.

### Second Embodiment

The present embodiment relates to another example of operations of the port number searching system shown in FIG. 5 for searching for and setting the data link connection relation between the optical transmission apparatuses 30 and 40.

In the first embodiment, the optical transmission apparatus 40, which is on the end of receiving the test message, monitors a specified reception port, and the optical transmission apparatus 30, which is on the end of transmitting the test message, transmits the test message while changing transmission ports sequentially.

To the contrary, in the present embodiment, the optical transmission apparatus 30 transmits the test message through the specified transmission port, and the optical transmission apparatus 40 receives the test message while changing reception ports sequentially.

As described above, the optical transmission apparatus 30 and the optical transmission apparatus 40 are independent from each other, and operations of the two apparatuses are described separately below.

### Operation of Apparatus for Transmitting Test Message

(1) <<Transmission of Test Message>>

Step 1:

The transmission port controller 38 sets the optical switch module 32 according to directions from the test message transmitter 35. For example, the transmission port #1 is specified at the beginning.

Step 2:

The test message transmitter 35 supplies the test message to the electrical-optical converter 39, and the electrical-optical converter 39 outputs optical signals of the test message. The test message optical signals are sent to the optical switch module 32.

Under control of the transmission port controller 38, the optical signals are transmitted from the specified transmission port to the data link. The test message transmitter 35 inserts the number of the transmission port in the test message in advance. For example, the transmission port number (#1) is inserted in the test message at the beginning.

Step 3:

The test message transmitter 35 repeatedly transmits the test message, separated by a predetermined period. In due course, the test message transmitter 35 receives, from the table management unit 33, a notification of the fact that the optical transmission apparatus 40 has received a test message, information on the port number for transmitting the test message, or directions for changing the transmission port.

Step 4:

The table management unit 33 directs the test message transmitter 35 to transmit the test message from the port having the smallest port number. Upon that, the operation in STEP 1 of section (1) is started.

Step 5:

After the operation of receiving the test message as described in section (3) below, the table management unit 33 changes the transmission port number to the next smallest one, and then repeats the above operations. After the largest port number is specified, the smallest port number is specified, again. Specifically, the test message transmitter 35 transmits the test message sequentially through the transmission port #1, then the transmission port #2, then the transmission port #3, and then back to the transmission port #1, and so on.

(2) <<Reception of Test Status Message>>

Step 1:

The test status message receiver 34 receives the test status message including the transmission port number in the optical transmission apparatus 30 and the reception port number in the optical transmission apparatus 40. The test status message is transmitted through the control channel. The received test status message is sent to the table management unit 33.

Step 2:

The table management unit.33 stores the transmission port number in the optical transmission apparatus 30 for sending the test message and the corresponding reception port numbers in the optical transmission apparatus 40 for receiving the test message, which are included in the received test status message, in the port number correspondence table 36.

Step 3:

The table management unit 33 undergoes the transmission operation in STEP 5 of section (1) as described above.

### Operation of Apparatus for Receiving Test Message

(3) <<Reception of Test Message>>

Step 1:

The test message receiver 45 notifies the reception port controller 48 of the specified reception port number for receiving the test message, and then the reception port controller 48 sets the optical switch module 42 so that the optical signals are received at the specified reception port via the optical-electrical converter 49. For example, the reception port #1 is specified at the beginning.

Therefore, the optical signals input to ports other than the specified reception port cannot reach the test message receiver 45. When optical signals are input to the specified reception-port, the operation in STEP2 of section (3) (described below) is performed. If the test message cannot be received over a specified time period, the test message waiting period is finished, and the operation in STEP2 of section (4) (described below) is performed.

Step 2:

When the test message receiver 45 receives the test message transmitted through the data link via the optical-electrical converter 49, the test message receiver 45 notifies the table management unit 43 of the test message and the reception port number for receiving the test message.

Step 3:

The table management unit 43 stores the transmission port number in the optical transmission apparatus 30 for sending the test message and the reception port number in the optical transmission apparatus 40 for receiving the test message, which are included in the received test message, in the port number correspondence table 46. Then, the table management unit 43 notifies the test status message transmitter 44 of the transmission port number in the optical transmission apparatus 30 for sending the test message and the reception port number in the optical transmission apparatus 40 for receiving the test message.

(4) <<Transmission of Test Status Message>>

Step 1:

The test status message transmitter 44 generates the test status message which includes the transmission port number in the optical transmission apparatus 30 for transmitting the test message and the reception port number in the optical transmission apparatus 40 for receiving the test message, and transmits the test status message to the optical transmission apparatus 30 through the control channel.

Step 2:

The test message receiver 45 changes the reception port number so that the test message is received through the next smallest port number, and repeats the operations from STEP 1 of section (3) through STEP 2 of section (4). After the largest port number is specified, the smallest port number is specified again. Specifically, the test message receiver 45 receives the test message sequentially through the reception port #1, then the reception port #2, then the reception port #3, and then back to the reception port #1, and so on.

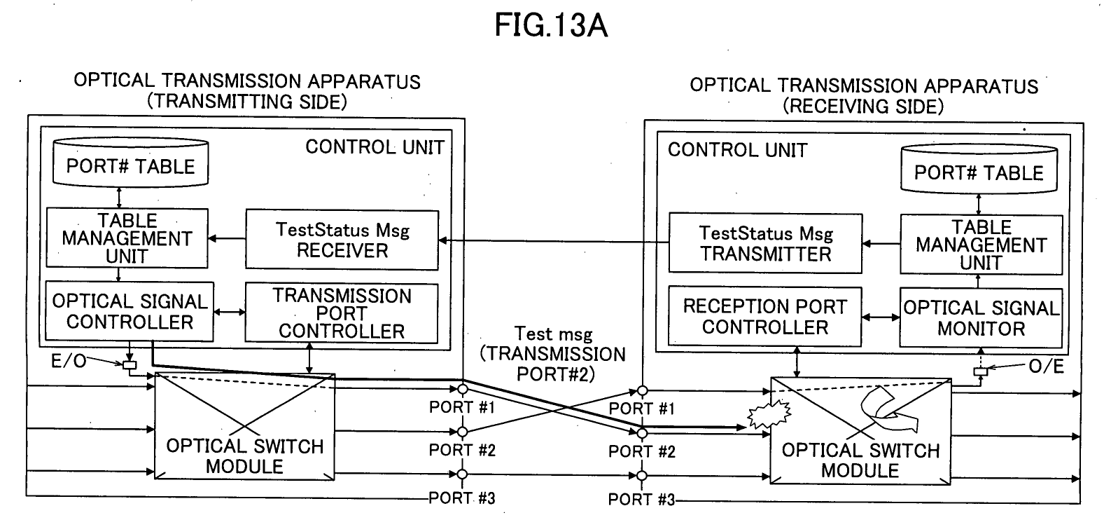

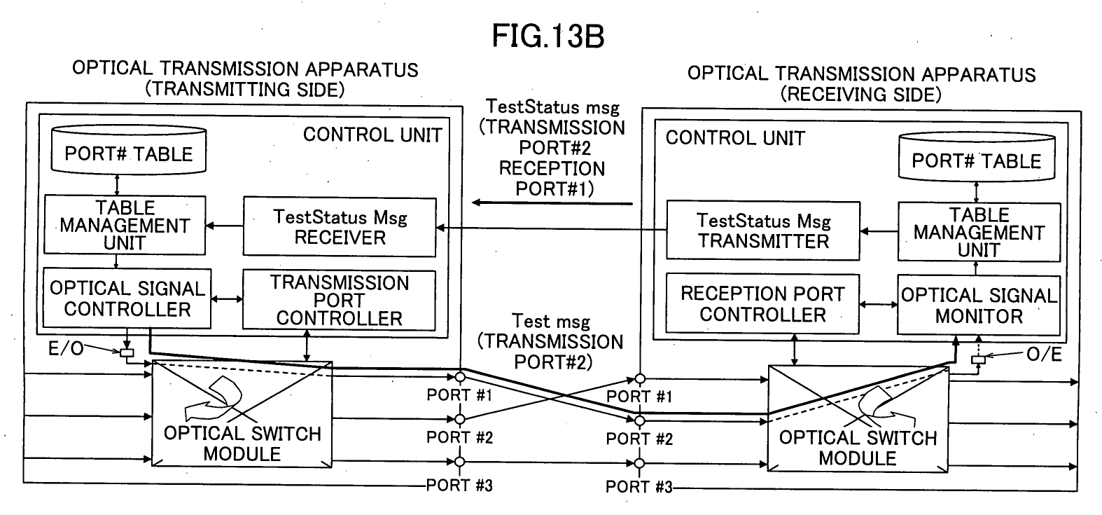

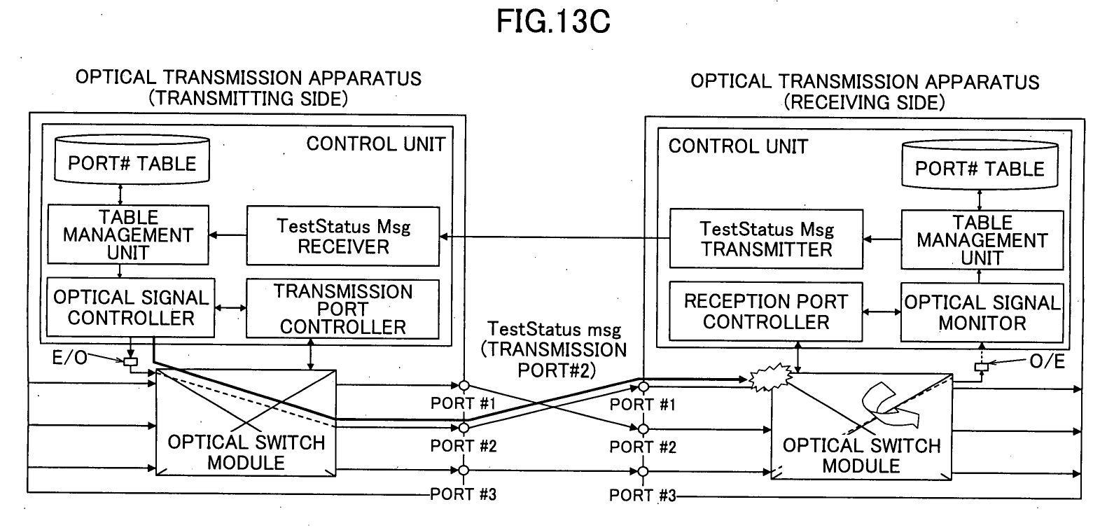

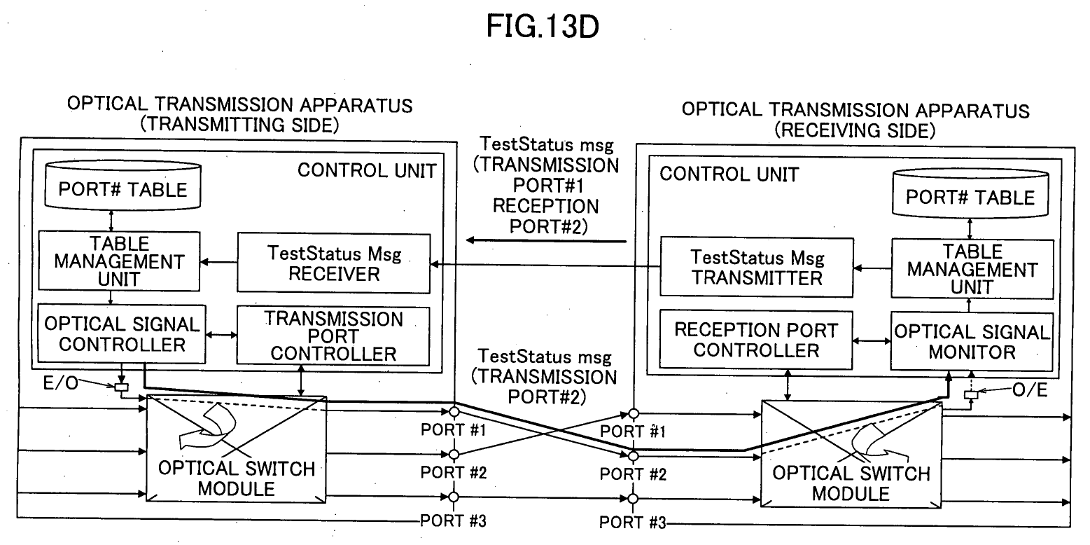

FIGS. 13A through 13D are block diagrams showing the operation of the port number searching system shown in FIG. 5 according to the present embodiment.

At first, the test message is transmitted through the transmission port #1 of the optical transmission apparatus 30.

In the optical transmission apparatus 40, it is set that the test message is to be received at the reception port #1. Because the port #1 of the optical transmission apparatus 30 and the port #1 of the optical transmission apparatus 40 are not connected, as shown in FIG. 13A, the optical transmission apparatus 40 fails in receiving the test message.

Then, after a predetermined time period, the test message receiver 45 requests the reception port controller 48 to change the reception port number for receiving the test message.

After receiving the request, the reception port controller 48 sets the optical switch module 42 so that the optical signals are to be received at the reception port #2.

Because the port #1 of the optical transmission apparatus 30 and the port #2 of the optical transmission apparatus 40 are connected, as shown in FIG. 13B, the optical transmission apparatus 40 succeeds in receiving the test message.

Then, subsequent to port #2, it is set that the test message is to be transmitted through the transmission port #2 of the optical transmission apparatus 30 and to be received at the port #3 in the optical transmission apparatus 40.

However, because the port #2 of the optical transmission apparatus 30 and the port #3 of the optical transmission apparatus 40 are not connected, as shown in FIG. 13C, the optical transmission apparatus 40 fails in receiving the test message.

Then, subsequent to port #3, it is set that the test message is received at the port #1 in the optical transmission apparatus 40. Because the port #2 of the optical transmission apparatus 30 and the port #1 of the optical transmission apparatus 40 are connected, as shown in FIG. 13D, the optical transmission apparatus 40 succeeds in receiving the test message.

Consequently, corresponding to port #1, port #2, and port #3 of the optical transmission apparatus 30, port #2, port #1, and port #3, respectively, of the optical transmission apparatus 40 are stored in the port number correspondence table 36 and the port number correspondence table 46.

In this way, despite a simple configuration, the optical transmission system according to the present invention is capable of automatically searching for and setting port numbers between two opposite optical transmission apparatuses.

### Third Embodiment

The present embodiment relates to an example of operations of the port number searching system shown in FIG. 6 for searching for and setting the data link connection relation between the optical transmission apparatuses 50 and 60.

The optical transmission apparatus 50 and the optical transmission apparatus 60 are independent from each other, and operations of the two apparatuses are described separately below.

### (Operation of Apparatus for Transmitting Optical Signals

(1) <<Transmission of Begin-Verify Message>>

Step 1:

The table management unit 53 notifies the Begin-Verify message transmitter 55 of the specified port number for transmitting the optical signals emitted from the laser 59. For example, the transmission port #1 is specified at the beginning.

Step 2:

The Begin-Verify message transmitter 55 transmits a Begin-Verify message including the transmission port number for transmitting the optical signals emitted from the laser 59 to the optical transmission apparatus 60 through the control channel.

(2) <<Transmission of Optical Signals>>

Step 1:

The table management unit 53 notifies the optical signal controller 57 of the port number for transmitting the optical signals emitted from the laser 59. For example, the transmission port #1 is specified at the beginning.

Step 2:

The optical signal controller 57 directs the transmission port controller 58 to set the optical switch module 52 so that the optical signals are output from the transmission port specified by the table management unit 53. For example, the transmission port #1 is set at the beginning.

Step 3:

The transmission port controller 58 sets the optical switch module 52 according to directions from the optical signal controller 57. For example, the transmission port #1 is specified at the beginning.

Step 4:

After setting the optical switch module 52, the optical signal controller 57 outputs the optical signals through the transmission port #1.

Step 5:

The table management unit 53 changes the transmission port number to the next smallest one, and then repeats the above operations. After the largest port number is specified, the smallest port number is specified, again. Specifically, the optical signals are transmitted through the transmission port #1, then the transmission port #2, then the transmission port #3, and then back to the transmission port #1, and so on.

(3) <<Reception of Test Status Message>>

Step 1:

The test status message receiver 54 receives the test status message, which is transmitted through the control channel and includes the reception port number in the optical transmission apparatus 60 for receiving the optical signals. Then the received test status message is sent to the table management unit 53.

Step 2:

The table management unit 53 stores the transmission port number in the optical transmission apparatus 50 for sending the optical signals and the corresponding reception port number in the optical transmission apparatus 60 for receiving the optical signals, which are included in the received test status message, in the port number correspondence table 56.

### Operation of Apparatus for Receiving Optical Signals

(4) <<Reception of Optical Signals>>

Step 1:

The optical signal monitor 67 notifies the reception port controller 68 of the specified reception port number for receiving the optical signals, and then the reception port controller 68 sets the optical switch module 62 so that the optical signals-are received via the specified reception port at the light receiver 69. For example, the reception port #1 is specified at the beginning.

The optical signals input to a port other than the specified reception port cannot reach the optical signal monitor 67. The following operations are performed when optical signals are input to the specified reception port.

Step 2:

The Begin-Verify message receiver 65 receives the Begin-Verify message, which includes the transmission port number in the optical transmission apparatus 50 for transmitting the optical signals, and is transmitted through the control channel.

Step 3:

After receiving the optical signals, the optical signal monitor 67 notifies the table management unit 63 of the reception port number.

Step 4:

The table management unit 63 stores the transmission port number in the optical transmission apparatus 50 for sending the optical signals and the reception port number in the optical transmission apparatus 60 for receiving the optical signals, which are included in the received Begin Verify message, in the port number correspondence table 66.

Then, the table management unit 63 notifies the test status message transmitter 64 of the reception port number in the optical transmission apparatus 60 for receiving the optical signals.

(5) <<Transmission of Test Status Message>>

Step 1:

The test status message transmitter 64 generates the test status message which includes the transmission port number in the optical transmission apparatus 50 for transmitting the optical signals and the reception port number in the optical transmission apparatus 60 for receiving the optical signals, and transmits the test status message to the optical transmission apparatus 50 through the control channel.

Step 2:

After the aforesaid operations in STEP 3 of section (4), the optical signal monitor 67 changes the reception port number so that the optical signals are received through the next smallest port number, and repeats the above operations. After the largest port number is specified, the smallest port number is specified again. Specifically, the optical signal monitor 67 receives the optical signals sequentially through the reception port #1, then the reception port #2, then the reception port #3, and then back to the reception port #1, and so on.

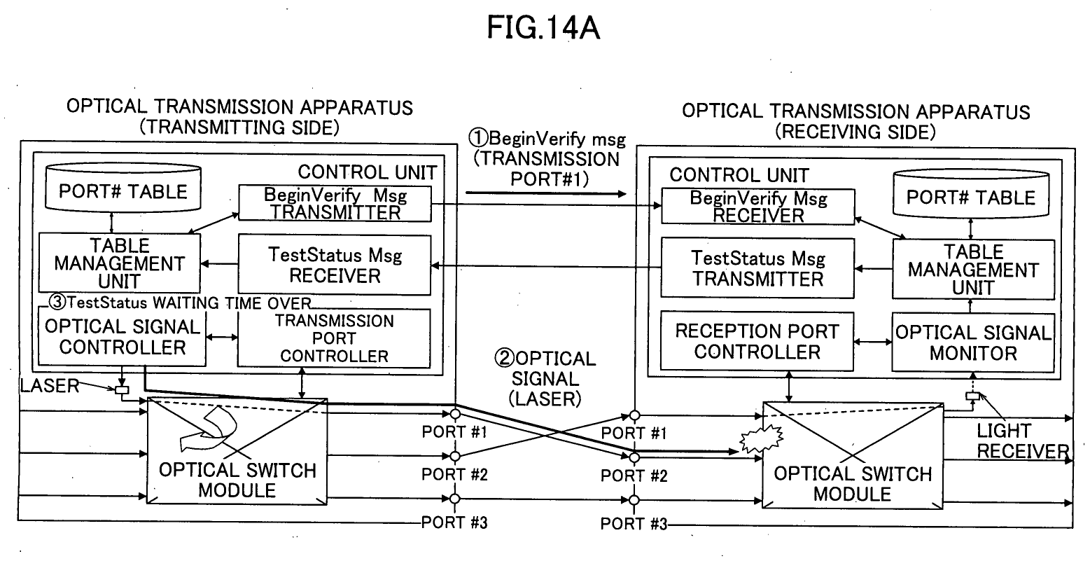

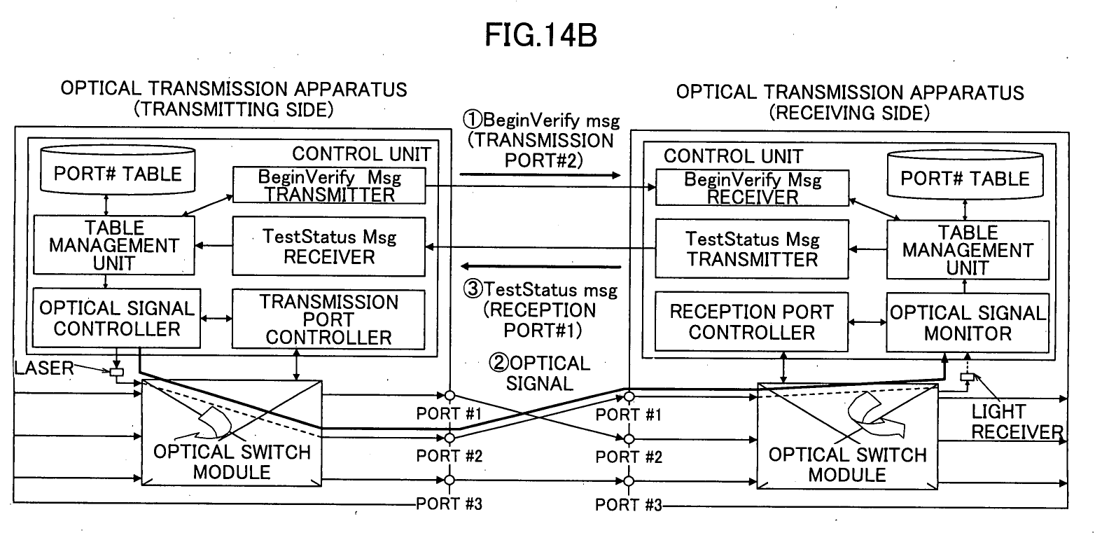

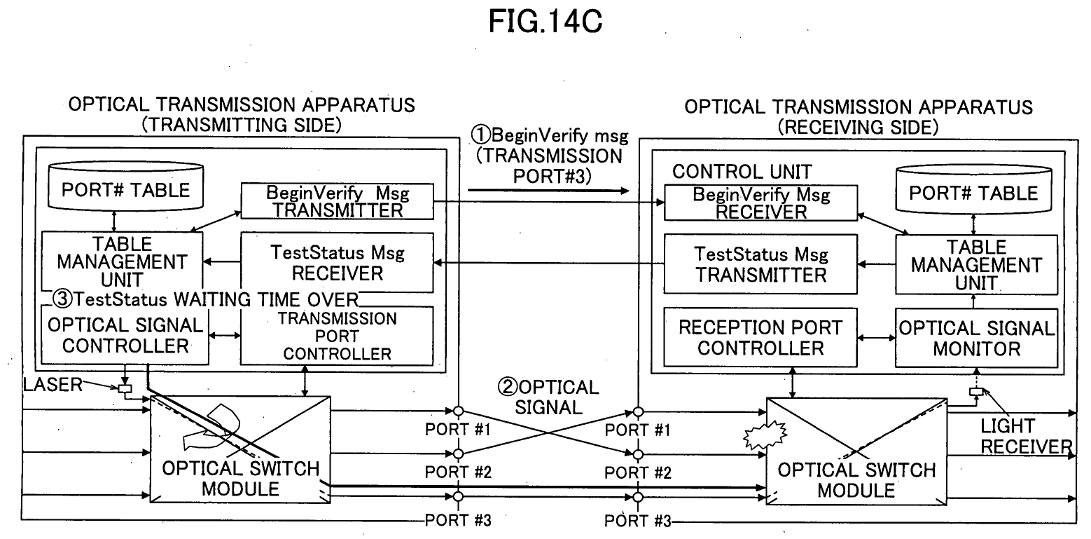

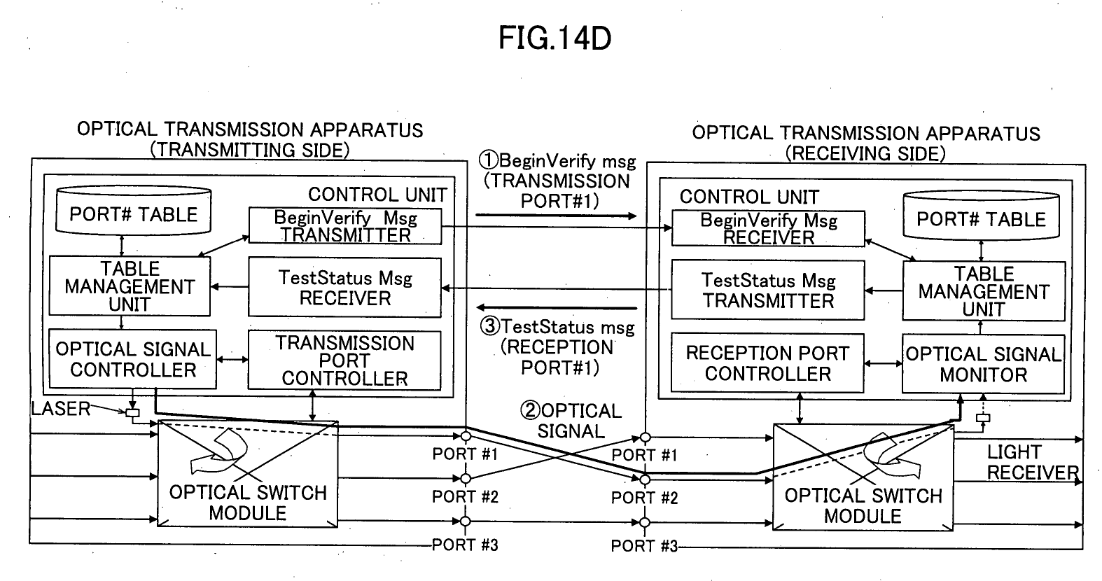

FIGS. 14A through 14D are block diagrams showing the operation of the port number searching system shown in FIG. 6 according to the present embodiment.

At first, the optical signals from the laser 59 are transmitted through the transmission port #1 of the optical transmission apparatus 50.

In the optical transmission apparatus 60, it is set that the optical signals are to be received at the reception port #1. Because the port #1 of the optical transmission apparatus 50 and the port #1 of the optical transmission apparatus 60 are not connected, as shown in FIG. 14A, the optical transmission apparatus 60 fails in receiving the optical signals.

Then, after a predetermined time period, the optical signal controller 57 requests the transmission port controller 58 to change the transmission port number for transmitting the optical signals.

After receiving the request, the transmission port controller 58 sets the optical switch module 52 so that the optical signals from the laser 59 are transmitted through the transmission port #2.

Because the port #2 of the optical transmission apparatus 50 and the port #1 of the optical transmission apparatus 60 are connected, as shown in FIG. 14B, the optical transmission apparatus 60 succeeds in receiving the optical signals.

Then, the optical transmission apparatus 60 performs the aforesaid operations in STEP 2, 3, and 4 of section (4) and STEP 1 and 2 of section (5). Thereby, in the optical transmission apparatus 60, it is set that the optical signals are to be received at the reception port #2.

On the side of the optical transmission apparatus 50, subsequent to port #2, it is set that the optical signals are transmitted through the port #3.

However, because the port #3 of the optical transmission apparatus 50 and the port #2 of the optical transmission apparatus 60 are not connected, as shown in FIG. 14C, the optical transmission apparatus 60 fails in receiving the test message.

Then, Begin-Verify message transmitter 55 changes the port number for transmitting the optical signals, and sets the optical switch module 52 so that the optical signals are transmitted through the transmission port #1. Because the port #1 of the optical transmission apparatus 50 and the port #2 of the optical transmission apparatus 60 are connected, as shown in FIG. 14D, the optical transmission apparatus 60 succeeds in receiving the test message.

Consequently, corresponding to port #1, port #2, and port #3 of the optical transmission apparatus 50, port #2, port #1, and port #3, respectively, of the optical transmission apparatus 60 are stored in the port number correspondence table 56 and the port number correspondence table 66.

In this way, despite a simple configuration, the optical transmission system according to the present invention is capable of automatically searching for and setting port numbers between two optical transmission apparatuses opposite to each other.

### Fourth Embodiment

The present embodiment relates to another example of operations of the port number searching system shown in FIG. 6 for searching for and setting the data link connection relation between the optical transmission apparatuses 50 and 60.

In the third embodiment, the optical transmission apparatus 60, which is on the end of receiving the optical signals, monitors a specified reception port, and the optical transmission apparatus 50, which is on the end of transmitting the optical signals, transmits the optical signals while changing the transmission port sequentially.

To the contrary, in the present embodiment, the optical transmission apparatus 50 transmits the optical signals through the specified transmission port, and the optical transmission apparatus 60 receives the optical signals while changing the reception port sequentially.

As described above, the optical transmission apparatus 50 and the optical transmission apparatus 60 are independent from each other, and operations of the two apparatuses are described separately below.

### Operation of Apparatus for Transmitting Optical Signals

(1) <<Transmission of Begin Verify Message>>

Step 1:

The table management unit 53 notifies the Begin-Verify message transmitter 55 of the specified port number for transmitting the optical signals emitted from the laser 59. For example, the transmission port #1 is specified at the beginning.

Step 2:

The Begin-Verify message-transmitter 55 transmits a Begin-Verify message including the transmission port number for transmitting the optical signals emitted from the laser 59 to the optical transmission apparatus 60 through the control channel.

(2) <<Transmission of Optical Signals>>

Step 1:

The table management unit 53 notifies the optical signal controller 57 of the port number for transmitting the optical signals emitted from the laser 59. For example, the transmission port #1 is specified at the beginning.

Step 2:

The optical signal controller 57 directs the transmission port controller 58 to set the optical switch module 52 so that the optical signals are output through the transmission port specified by the table management unit 53. For example, the transmission port #1 is set at the beginning.

Step 3:

The transmission port controller 58 sets the optical switch module 52 according to directions from the optical signal controller 57. For example, the transmission port #1 is set at the beginning.

Step 4:

After setting the optical switch module 52, the optical signal controller 57 outputs the optical signals through the transmission port #1.

Step 5:

After receiving the test status message as described below, the table management unit 53 changes the transmission port number to the next smallest one, and then repeats the above operations. After the largest port number is specified, the smallest port number is specified, again. Specifically, the optical signals are transmitted through the transmission port #1, then the transmission port #2, then the transmission port #3, and then back to the transmission port #1, and so on.

(3) <<Reception of Test Status Message>>

Step 1:

The test status message receiver 54 receives the test status-message, which is transmitted through the control channel and includes the reception port number in the optical transmission apparatus 60 for receiving the optical signals. Then the received test status message is sent to the table management unit 53.

Step 2:

The table management unit 53 stores the transmission port number in the optical transmission apparatus 50 for sending the optical signals and the corresponding reception port number in the optical transmission apparatus 60 for receiving the optical signals, which are included in the received test status message, in the port number correspondence table 56.

Step 3:

The table management unit 53 performs the operation in STEP 5 of section (2).

Step 4:

The above operations are repeated.

### Operation of Apparatus for Receiving Optical Signals

(4) <<Reception of Begin-Verify Message>>

Step 1:

The Begin-Verify message receiver 65 receives the Begin-Verify message, which includes the transmission port number in the optical transmission apparatus 50 for transmitting the optical signals from the laser 59, and is transmitted through the control channel. Then, the Begin-Verify message receiver 65 notifies the table management unit 63 of the transmission port number through which the optical transmission apparatus 50 transmits the optical signals.

(5) <<Reception of Optical Signals>>

Step 1:

The optical signal monitor 67 notifies the reception port controller 68 of the specified reception port number for receiving the optical signals, and then the reception port controller 68 sets the optical switch module 62 so that the optical signals are received at the specified reception port via the light receiver 69. For example, the reception port #1 is specified at the beginning.

The optical signals input to a port other than the specified reception port cannot reach the optical signal monitor 67. The following operations are performed when optical signals are input to the specified reception port. When optical signals are input to the specified reception port, the operation described below is performed. If the control unit 61 cannot receive the optical signals over a specified time period, the optical signal waiting period is finished, and the operation in section (6) below is performed.

Step 2:

After receiving the optical signals, the optical signal monitor 67 notifies the table management unit 63 of the reception port number.

Step 3:

The table management unit 63 stores the transmission port number in the optical transmission apparatus 50 for sending the optical signals and the reception port number in the optical transmission apparatus 60 for receiving the optical signals, which are included in the received Begin-Verify message, in the port number correspondence table 66. Then, the table management unit 63 notifies the test status message transmitter 64 of the reception port number in the optical transmission apparatus 60 for receiving the optical signals.

Step 4:

The test status message transmitter 64 generates the test status message which includes the transmission port number in the optical transmission apparatus 50 for transmitting the optical signals and the reception port number in the optical transmission apparatus 60 for receiving the optical signals, and transmits the test status message to the optical transmission apparatus 50 through the control channel.

(6) <<Repetition of Operations>>

Step 1:

The optical signal monitor 67 changes the reception port number so that the optical signals are received at the next smallest port number, and repeats the operation in aforesaid STEP 1 of section (5). The reception port controller 68 sets the optical switch module 62 so that the optical signals are received at the reception port #2 via the light receiver 69. After the largest port number is specified, the smallest port number is specified again. Specifically, the optical signal monitor 67 receives the optical signals sequentially through the reception port #1, then the reception port #2, then the reception port #3, and then back to the reception port #1, and so on.

Step 2:

After receiving the Begin-Verify message, the aforesaid operations from STEP 1 of section (4) are performed again, alternatively only the operation in STEP 1 of section (5) is performed asynchronously while the operations from STEP 1 of section (5) through STEP 1 of section (6) are repeated to update the transmission port number in the table management unit 63.

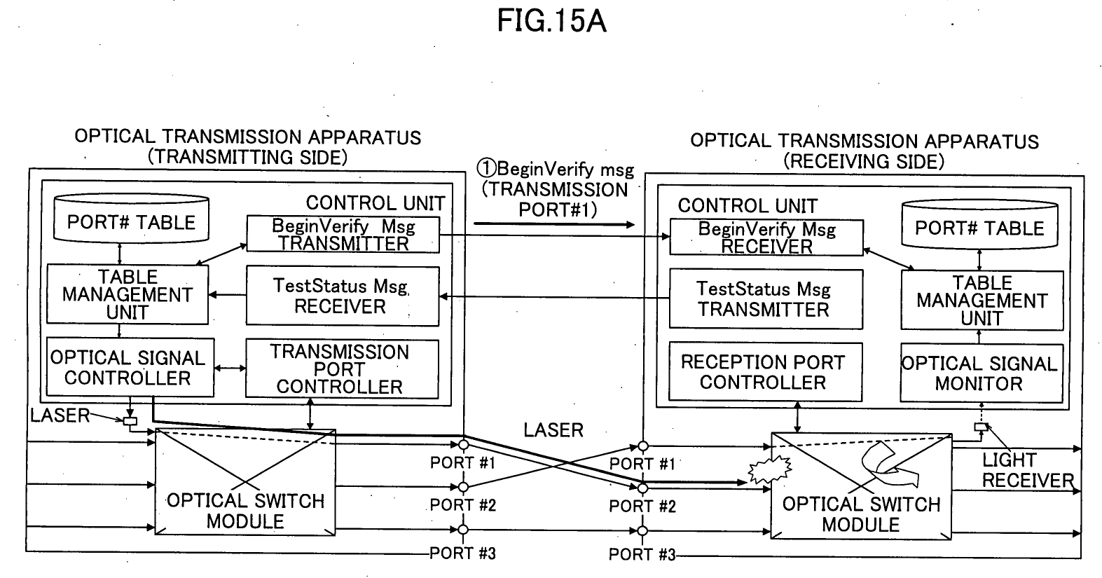

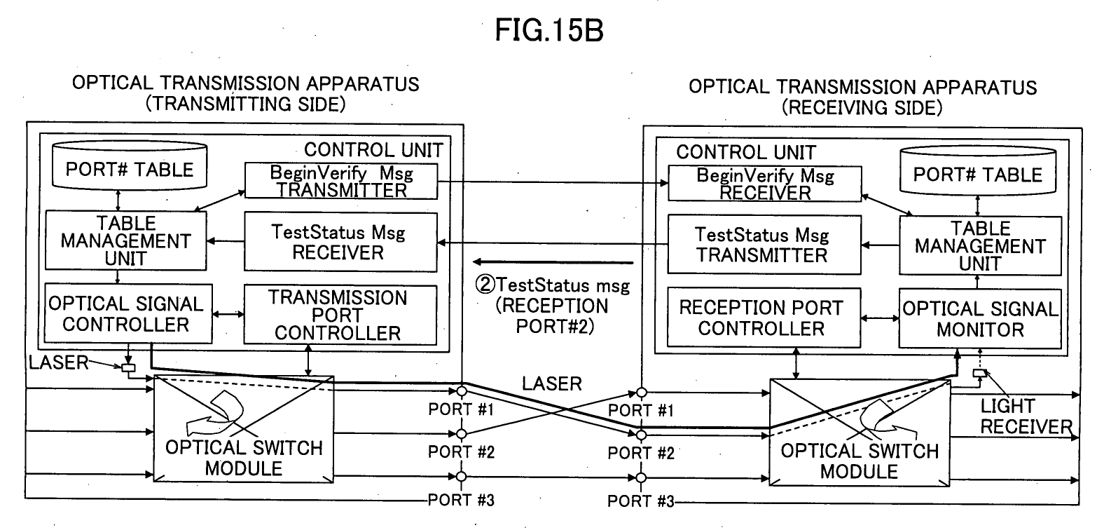

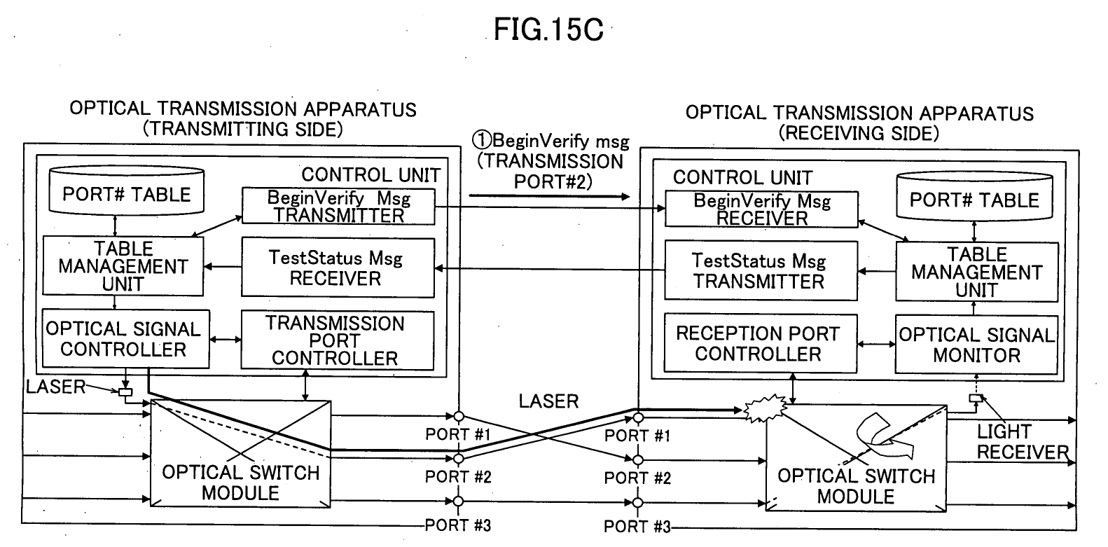

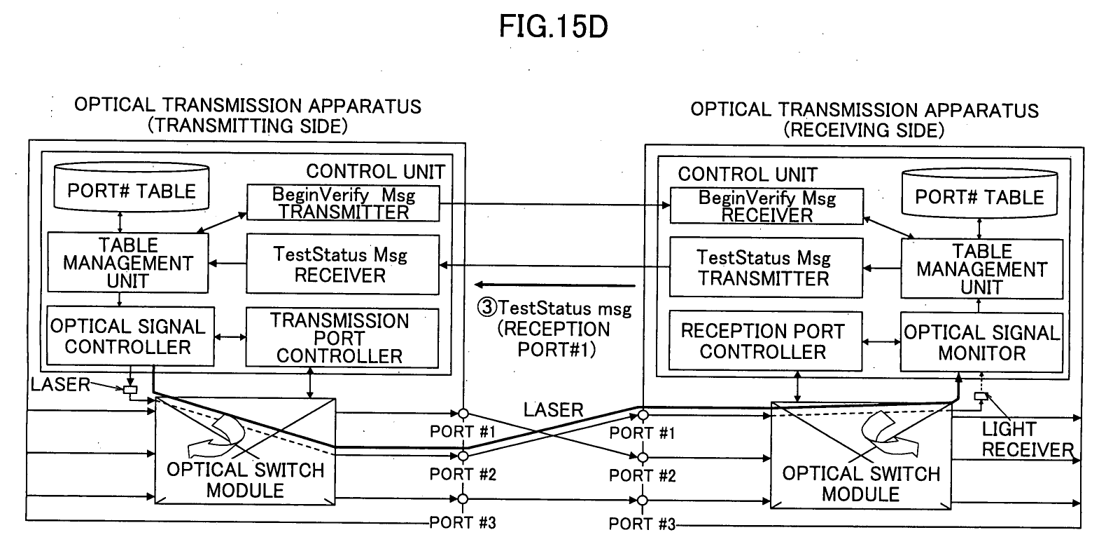

FIGS. 15A through 15D are block diagrams showing the operation of the port number searching system shown in FIG. 6 according to the present embodiment.

At first, the optical signals from the laser 59 are transmitted through the transmission port #1 of the optical transmission apparatus 50.

In the optical transmission apparatus 60, it is set that the optical signals are to be received at the reception port #1. Because the port #1 of the optical transmission apparatus 50 and the port #1 of the optical transmission apparatus 60 are not connected, as shown in FIG. 15A, the optical transmission apparatus 60 fails in receiving the optical signals.

Then, after a predetermined time period, the optical signal monitor 67 requests the reception port controller 68 to change the reception port number for receiving the optical signals.

After receiving the request, the reception port controller 68 sets the optical switch module 62 so that the optical signals are received at the reception port #2.

Because the port #1 of the optical transmission apparatus 50 and the port #2 of the optical transmission apparatus 60 are connected, as shown in FIG. 15B, the optical transmission apparatus 60 succeeds in receiving the optical signals.

Then, subsequent to the reception port #2, the optical signals from the laser 59 are transmitted through the transmission port #2 of the optical transmission apparatus 50, and the reception port controller 68 sets the optical switch module 62 so that the optical signals are to be received at the reception port #3.

Because the port #2 of the optical transmission apparatus 50 and the port #3 of the optical transmission apparatus 60 are not connected, as shown in FIG. 15C, the optical transmission apparatus 60 fails in receiving the optical signals.

Then, subsequent to the reception port #3, the reception port controller 68 sets the optical switch module 62 so that the optical signals are received at the reception port #1.

Because the port #2 of the optical transmission apparatus 50 and the port #1 of the optical transmission apparatus 60 are connected, as shown in FIG. 15D, the optical transmission apparatus 60 succeeds in receiving the optical signals.

Consequently, corresponding to port #1, port #2, and port #3 of the optical transmission apparatus 50, port #2, port #1, and port #3, respectively, of the optical transmission apparatus 60 are stored in the port number correspondence table 56 and the port number correspondence table 66.

In this way, despite a simple configuration, the optical transmission system according to the present invention is capable of automatically searching for and setting port numbers between two opposite optical transmission apparatuses.

### Fifth Embodiment

The present embodiment relates to an example of operations of the port number searching system shown in FIG. 7 for searching for and setting the data link connection relation between the optical transmission apparatuses 70 and 90.

The optical transmission apparatus 70 and the optical transmission apparatus 90 are independent from each other, and operations of the two apparatuses are described separately below.

### Operation of Apparatus for Transmitting Test Signals

(1) <<Transmission of Begin-Verify Message>>

Step 1:

The table management unit 73 notifies the Begin-Verify message transmitter 75 of the specified port number for transmitting the test signals. For example, the transmission port #1 is specified at the beginning.

It should be noted that any optical signals may be used as the test signals as long as the signals can be identified as test signals used for searching for and setting of the data link connection relation.

Step 2:

The Begin-Verify message transmitter 75 transmits a Begin-Verify message including the transmission port number for transmitting the test signals to the optical transmission apparatus 90 through the control channel.

(2) <<Transmission of Test Signals>>

Step 1:

The table management unit 73 notifies the optical signal controller 77 of the port number for transmitting optical signals, for example, emitted from a laser.

Step 2:

The optical signal controller 77 controls the laser in the transponder at the transmission port specified by the table management unit 73 to emit light, and transmits optical signals to the optical transmission apparatus 90.

Step 3:

After receiving the test status message as described below, the table management unit 73 changes the transmission port number to the next smallest one, and then repeats the above operations. After the largest port number is specified, the smallest port number is specified, again.

(3) <<Reception of Test Status Message>>

Step 1:

The test status message receiver 74 receives the test status message, which is transmitted through the control channel and includes the reception port number in the optical transmission apparatus 90 for receiving the optical signals. Then the received test status message is sent to the table management unit 73.

Step 2:

The table management unit 73 stores the transmission port number in the optical transmission apparatus 70 for sending the optical signals and the corresponding reception port number in the optical transmission apparatus 90 for receiving the optical signals, which are included in the received test status message, in the port number correspondence table 76.

Step 3:

The table management unit 73 performs the operation in STEP 3 of section (2) as described above.

Step 4:

The above operations are repeated. Specifically, the optical signals are transmitted through the transmission port #1, then the transmission port #2, then the transmission port #3, and then back to the transmission port #1, and so on.

### Operation of Apparatus for Receiving Test Signals (4) <<Reception of Begin-Verify Message>>

Step 1:

The Begin-Verify message receiver 95 receives the Begin-Verify message, which includes the transmission port number in the optical transmission apparatus 70 for transmitting the test signals, and is transmitted through the control channel. Then, the Begin-Verify message receiver 95 notifies the table management unit 93 of the transmission port number through which the optical transmission apparatus 70 transmits the optical signals.

(5) <<Reception of Optical Signals>>

Step 1:

The optical signal monitor 97 notifies the table management unit 93 of the reception port number for receiving the optical signals.

Step 2:

The table management unit 93 stores the transmission port number in the optical transmission apparatus 70 for sending the optical signals and the reception port number in the optical transmission apparatus 90 for receiving the optical signals, which are included in the received Begin-Verify message, in the port number correspondence table 96. Then, the table management unit 93 notifies the test status message transmitter 94 of the reception port number in the optical transmission apparatus 90 for receiving the optical signals.

Step 3:

The test status message transmitter 94 generates the test status message which includes the reception port number in the optical transmission apparatus 90 for receiving the optical signals, and transmits the test status message to the optical transmission apparatus 70 through the control channel.

Step 4:

Each time the Begin-Verify message is received, the above operations are repeated.

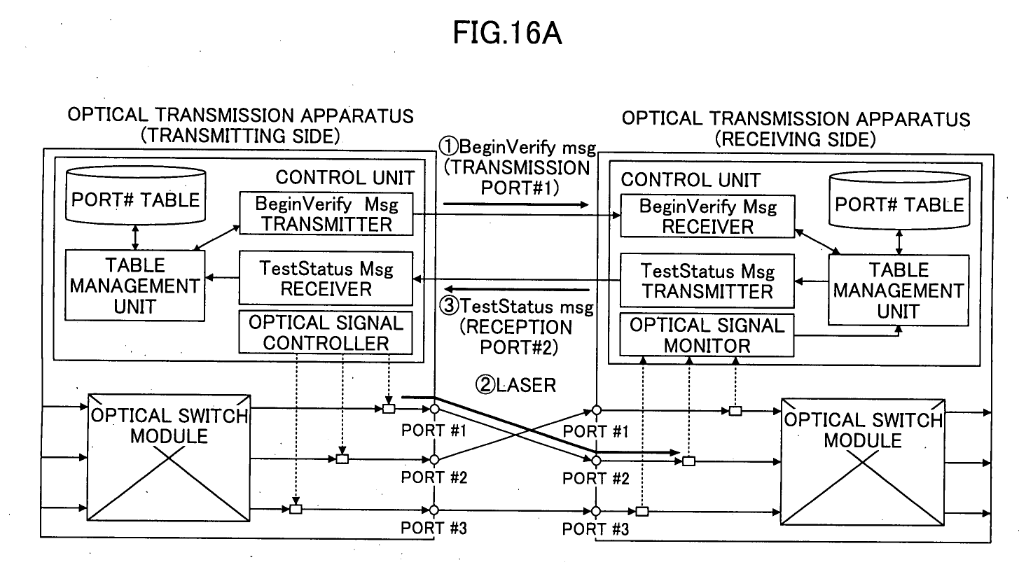

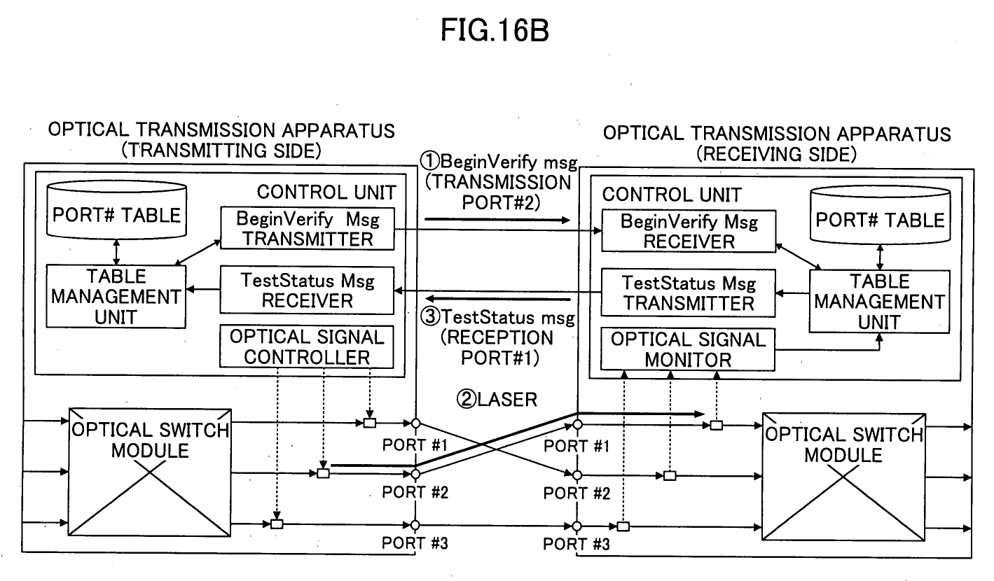

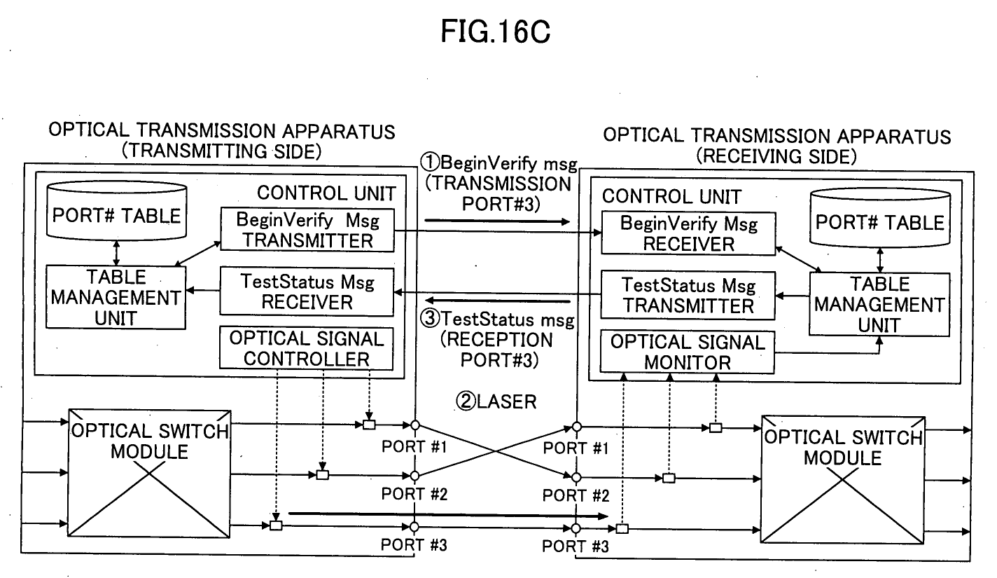

FIGS. 16A through 16C are block diagrams showing the operation of the port number searching system shown in FIG. 7 according to the present embodiment.

At first, the test message is transmitted through the transmission port #1 of the optical transmission apparatus 70.

In the optical transmission apparatus 90, it is set that the test message sent from port #1 of the optical transmission apparatus 70 is to be received at the reception port #2, and the optical signal monitor 97 monitors the reception operation.

Based on the reception port #2 of the optical transmission apparatus 90 given by the optical signal monitor 97, and the transmission port #1 of the optical transmission apparatus 70 given by the Begin-Verify message received by the Begin Verify message receiver 95, the table management unit 93 stores the transmission port #1 in the optical transmission apparatus 70 for sending the optical signals and the reception port #2 in the optical transmission apparatus 90 for receiving the optical signals in the port number correspondence table 96.

Similarly, the transmission port #2 and port #3 of the optical transmission apparatus 70, as shown in FIGS. 16B and 16C, respectively, are also stored in the respective port number correspondence tables 76 and 96 after searching for the correspondence relation with the transmission port.

Consequently, corresponding to port #1, port #2, and port #3 of the optical transmission apparatus 70, port #2, port #1, and port #3, respectively, of the optical transmission apparatus 90 are stored in the port number correspondence table 76 and the port number correspondence table 96.

In this way, despite a simple configuration, the optical transmission system according to the present invention is capable of automatically searching for and setting port numbers between two opposite optical transmission apparatuses.

### First Modification

In the first embodiment, it is shown that each of the optical transmission apparatuses 30 and 40 has only one electrical-optical converter 39 or one optical-electrical converter 49. But the optical transmission apparatus 30 (or the optical transmission apparatus 40) may have a number of electrical-optical converters 39 (or optical-electrical converters 49). With such a configuration, it is possible to shorten the time required for searching for and setting port numbers between two opposite optical transmission apparatuses.

Specifically, in the optical transmission apparatus 30, the transmission port controller 38 sets the optical switch module 32 so that the optical signals from a number of electrical-optical converters 39 on the input side of the optical switch module 32 are transmitted through a number of transmission ports, enabling simultaneous transmission of many test messages through the transmission ports.

After test messages are transmitted through all of the electrical-optical converters 39, the transmission port controller 38 sets the optical switch module 32 so that the optical signals from the electrical-optical converters 39 are transmitted through transmission ports that have not yet been used for transmission.

In the optical transmission apparatus 40, by similar operations as described above, it is possible to simultaneously receive a number of test messages at a number of reception ports.

This modification is also applicable to the second embodiment.

### Second Modification

In the first embodiment, it is shown that the optical transmission apparatus 40 is able to receive a test message, no matter which reception port the optical transmission apparatus 40 is monitoring, provided that the optical transmission apparatus 30 sends the test message from all of the transmission ports. This scheme works if the there is no trouble in the transmission channels or in the case that all links are established between the optical transmission apparatuses opposite to each other. However, if the test message is lost, the optical transmission apparatus 40 may keep monitoring a specific reception port, and the optical transmission apparatus 40 may stop operating. For this reason, a test message waiting timer is provided, and the test message waiting timer is reset each time a test message is received. The test message waiting timer overflows if the test message does not come due to transmission trouble, for example. When overflow occurs, the test message receiver changes the reception port being monitored to the next port.

This modification is also applicable to the third embodiment.

Similarly, in the second embodiment and the fourth embodiment, a test message waiting timer is provided, and if the test message does not come due to transmission trouble, the test message transmitter changes the transmission port being used.

### Third Modification

In LMP, a so-called “link summary message” is exchanged through a control channel between the optical transmission apparatuses opposite to each other. The link summary message is used for inputting configuration and definition information to the optical transmission apparatuses by using files or commands to create a port number correspondence table. By exchanging the link summary message between the optical transmission apparatuses opposite to each other based on the information stored in the optical transmission apparatuses, it is possible to confirm whether the data link connection relation is correctly recognized.

By exchanging the link summary message, the ports not in agreement between the optical transmission apparatuses opposite to each other, or the ports not recognized, are used in operations described in the first embodiment.

It is not necessary to simply increment the port number in order to conduct this confirmation; the ports not needed to be searched for can be skipped, thereby, it is possible to search for and set the data link connection relation in a short time.

This modification is also applicable to all the above embodiments.

Further, when errors occur, it is possible to use those ports desired to be searched for again to execute operations in the first through fifth embodiments.

While the invention is described above with reference to specific embodiments chosen for purpose of illustration, it should be apparent that the invention is not limited to these embodiments, but numerous modifications could be made thereto by those skilled in the art without departing from the basic concept and scope of the invention.

In the above embodiments, the number of the ports in each optical transmission apparatus is assumed to be three, but the present invention is not limited to this number.

The present invention is also applicable to transmission apparatuses not based on WDM.

In WDM transmission apparatuses, when setting the data link connection relation between two apparatuses, a WDM multiplexer may be installed in the optical transmission apparatus on the transmitting side, which transmits the test message, optical signals, or the test signals, and a WDM de-multiplexer may be installed in the optical transmission apparatus for receiving the test message, optical signals, or the test signals.

Summarizing the effect of the present invention, with a simple configuration, the optical transmission system of the present invention is capable of automatically searching for and setting port numbers between two opposite optical transmission apparatuses.

This patent application is based on Japanese Priority Patent Application No. 2003-088140 filed on Mar. 27, 2003, the entire contents of which are hereby incorporated by reference.

What is claimed is:

1. An optical transmission system including:
a first optical transmission apparatus having a first optical switch; and
a second optical transmission apparatus having a second optical switch,
said optical transmission system being capable of setting a connection relation between the first optical transmission apparatus and the second optical transmission apparatus,
wherein
the first optical transmission apparatus includes:
a first transmission unit provided on an input side of the first optical switch configured to transmit a first control message including a transmission port number of a transmission port for transmitting the first control message; and
a transmission port control unit configured to control the first optical switch so that the first control message is transmitted through different transmission ports sequentially.

2. The optical transmission system as claimed in claim 1, wherein
the second optical transmission apparatus includes:
a first reception unit provided on an output side of the second optical switch configured to receive the first control message; and
a reception port control unit configured to control the second optical switch so that the first control message is received by the first reception unit through different reception ports sequentially.

3. The optical transmission system as claimed in claim 1, wherein
the transmission port control unit controls the first optical switch so that the first control message is transmitted through different transmission ports sequentially and periodically.

4. The optical transmission system as claimed in claim 2, wherein
after receiving the first control message, the first reception unit controls the reception port control unit so as to receive the first control message next time through a reception port having a reception port number next to a present reception port number.

5. The optical transmission system as claimed in claim 2, wherein
the first optical transmission apparatus further comprises a second reception unit configured to receive a second control message including the transmission port number and a reception port number of the second optical transmission apparatus for receiving the first control message,
wherein
after the second reception unit receives the second control message, the first transmission unit transmits a control message as the first control message from a transmission port having a transmission port number next to the transmission port number included in the second control message, the next transmission port number being included in the control message transmitted by the first transmission unit as the first control message.

6. The optical transmission system as claimed in claim 5, wherein
the second optical transmission apparatus further comprises a second transmission unit configured to transmit the second control message,
wherein
the reception port control unit controls the second optical switch so that the first control message is received through different reception ports sequentially and periodically.

7. An optical transmission system including:
a first optical transmission apparatus having a first optical switch; and
a second optical transmission apparatus having a second optical switch,
said optical transmission system being capable of setting a connection relation between the first optical transmission apparatus and the second optical transmission apparatus,
wherein
the first optical transmission apparatus includes:
an optical signal transmission unit provided on an input side of the first optical switch configured to transmit an optical signal;
a first transmission unit configured to transmit a first control message including a transmission port number of a transmission port for transmitting the optical signal; and
a transmission port control unit configured to control the first optical switch so that the optical signal is transmitted through different transmission ports sequentially and periodically.

8. The optical transmission system as claimed in claim 7, wherein
the second optical transmission apparatus includes:
an optical signal reception unit provided on an output side of the second optical switch configured to receive the optical signal; and
a reception port control unit configured to control the second optical switch so that the optical signal is received by the optical signal reception unit through different reception ports sequentially,
wherein
after receiving the optical signal, the optical signal reception unit controls the reception port control unit so as to receive the optical signal next time through a reception port having a reception port number next to a present reception port number.

9. An optical transmission system including:
a first optical transmission apparatus having a first optical switch; and
a second optical transmission apparatus having a second optical switch,
said optical transmission system being capable of setting a connection relation between the first optical transmission apparatus and the second optical transmission apparatus,
wherein
the first optical transmission apparatus includes:
an optical signal transmission unit provided on an input side of the first optical switch configured to transmit an optical signal;
a transmission port control unit configured to control the first optical switch;
a first transmission unit configured to transmit a first control message including a transmission port number of a transmission port for transmitting the optical signal; and
a first reception unit configured to receive a second control message including the transmission port number and a reception port number of a reception port of the second optical transmission apparatus for receiving the optical signal,
wherein
after the first reception unit receives the second control message, the transmission port control unit controls the first optical switch so that the optical signal is transmitted through a transmission port having a transmission port number next to the transmission port number included in the second control message.

10. The optical transmission system as claimed in claim 9, wherein
the second optical transmission apparatus includes:
an optical signal reception unit provided on an output side of the second optical switch configured to receive the optical signal;
a reception port control unit configured to control the second optical switch so that the optical signal is received by the optical signal reception unit through different reception ports sequentially;
a second transmission unit configured to transmit the second control message; and
a second reception unit configured to receive the first control message,
wherein
the optical signal reception unit controls the reception port control unit so as to receive the optical signal through different reception ports sequentially and periodically.

11. An optical transmission system including:
a first optical transmission apparatus having a first optical switch; and
a second optical transmission apparatus having a second optical switch,
said optical transmission system being capable of setting a connection relation between the first optical transmission apparatus and the second optical transmission apparatus,
wherein
the first optical transmission apparatus includes:
a test signal transmission unit provided on an input side of the first optical switch configured to transmit a test signal;
a transmission unit configured to transmit a control message including a transmission port number of a transmission port for transmitting the test signal,
wherein
the test signal transmission unit transmits the test signal through different transmission ports sequentially, separated by a predetermined time period.

12. The optical transmission system as claimed in claim 11, wherein
the second optical transmission apparatus includes:
a test signal reception unit provided on an output side of the second optical switch configured to receive the test signal to monitor a reception state;
a reception unit configured to receive the control message.

13. An optical transmission system including:
a first optical transmission apparatus having a first optical switch; and
a second optical transmission apparatus having a second optical switch,
said optical transmission system being capable of setting a connection relation between the first optical transmission apparatus and the second optical transmission apparatus,
wherein
the first optical transmission apparatus includes:
a test signal transmission unit provided on an input side of the first optical switch configured to transmit a test signal;
a first transmission unit configured to transmit a first control message including a transmission port number of a transmission port for transmitting the test signal; and
a first reception unit configured to receive a second control message including the transmission port number and a reception port number of a reception port of the second optical transmission-apparatus for receiving the test signal,
wherein
after the first reception unit receives the second control message, the test signal transmission unit transmits the test signal through a transmission port having a transmission port number next to the transmission port number included in the second control message.

14. The optical transmission system as claimed in claim 13, wherein
the second optical transmission apparatus includes:
a test signal reception unit provided on an output side of the second optical switch configured to receive the test signal to monitor a reception state;
a second transmission unit configured to transmit the second control message; and
a second reception unit configured to receive the first control message.

15. The optical transmission system as claimed in claim 1, wherein
the first transmission unit transmits a plurality of control messages simultaneously.

16. The optical transmission system as claimed in claim 2, further comprising
a control message reception waiting timer that starts to count the time when the first control message is received, and terminates after a predetermined time period,
wherein
when the control message reception waiting timer terminates, the reception port control unit controls the second optical switch so that the first control message is received through a different reception port.

17. The optical transmission system as claimed in claim 7, wherein
the second optical transmission apparatus includes:
an optical signal reception unit provided on an output side of the second optical switch configured to receive the optical signal;
a reception port control unit configured to control the second optical switch so that the optical signal is received by the optical signal reception unit through different reception ports sequentially; and
a control message reception waiting timer that starts to count the time when the first control message is received, and terminates after a predetermined time period,
wherein
when the control message reception waiting timer terminates, the reception port control unit controls the second optical switch so that the first control message is received through a different reception port.

18. The optical transmission system as claimed in claim 1, wherein
the first optical transmission apparatus includes:
a first reception unit configured to receive a second control message including the transmission port number and a reception port number of a reception port of the second optical transmission apparatus for receiving the first control message; and
a control message reception waiting timer that starts to count the time when the second control message is received, and terminates after a predetermined time period,
wherein
when the control message reception waiting timer terminates, the transmission port control unit controls the first optical switch so that the first control message is transmitted through a next transmission port, the next transmission port number being included in said transmitted first control message.

19. An optical transmission system including:
a first optical transmission apparatus having a first optical switch; and
a second optical transmission apparatus having a second optical switch,
said optical transmission system being capable of setting a connection relation between the first optical transmission apparatus and the second optical transmission apparatus
wherein
the first optical transmission apparatus includes:
an optical signal transmission unit provided on an input side of the first optical switch configured to transmit an optical signal;
a transmission port control unit configured to control the first optical switch;
a first transmission unit configured to transmit a first control message including a transmission port number of a transmission port for transmitting the optical signal;
a first reception unit configured to receive a second control message including the transmission port number and a reception port number of a reception port of the second optical transmission apparatus for receiving the optical signal; and
a control message reception waiting timer that starts to count the time when the second control message is received, and terminates after a predetermined time period,
wherein
when the control message reception waiting timer terminates, the transmission port control unit controls the first optical switch so that the-first control message is transmitted from a next transmission port.

20. The optical transmission system as claimed in claim 1, wherein
a link summary-message including a connection relation between the first optical transmission apparatus and the second optical transmission apparatus is exchanged therebetween; and
transmission ports and reception ports not in agreement or not recognized in the connection relation between the first optical transmission apparatus and the second optical transmission apparatus are used for searching for and setting the transmission port number and a reception port number.

21. The optical transmission system as claimed in claim 1, wherein
when errors occur in transmission between the first optical transmission apparatus and the second optical transmission apparatus,
transmission ports and reception ports related to the erroneous transmission are used for searching for and setting the transmission port number and a reception port number.

22. An optical transmission apparatus having an optical switch capable of setting a connection relation with another optical transmission apparatus opposite thereto, including:
a transmission unit provided on an input side of the optical switch configured to transmit a first control message including a transmission port number of a transmission port for transmitting the first control message; and
a transmission port control unit configured to control the optical switch so that the first control message is transmitted through different transmission ports sequentially.

23. The optical transmission apparatus as claimed in claim 22, wherein the transmission port control unit controls the optical switch so that the first control message is transmitted through different transmission ports sequentially and periodically.

24. The optical transmission apparatus as claimed in claim 22, further comprising
a reception unit configured to receive a second control message including the transmission port number and a reception port number of the opposite optical transmission apparatus for receiving the first control message,
wherein
after the reception unit receives the second control message, the transmission unit transmits a control message as the first control message from a transmission port having a transmission port number next to the transmission port number included in the second control message, the next transmission port number being included in the transmitted control message.

25. An optical transmission apparatus having an optical switch capable of setting a connection relation with another optical transmission apparatus opposite thereto, including:
a reception unit provided on an output side of the optical switch configured to receive a control message; and
a reception port control unit configured to control the optical switch so that the control message is received through different reception ports sequentially.

26. The optical transmission apparatus as claimed in claim 25, wherein
after receiving the control message, the reception unit controls the reception port control unit so as to receive the control message next time through a reception port having a reception port number next to a present reception port number.

27. The optical transmission apparatus as claimed in claim 26, wherein
the reception port control unit controls the optical switch so that the control message is received through different reception ports sequentially and periodically.

28. An optical transmission apparatus having an optical switch capable of setting a connection relation with another optical transmission apparatus opposite thereto, including:
an optical signal transmission unit provided on an input side of the optical switch configured to transmit an optical signal;
a transmission unit configured to transmit a control message; and
a transmission port control unit configured to control the optical switch so that the optical signal is transmitted through different transmission ports sequentially and periodically.

29. An optical transmission apparatus having an optical switch capable of setting a connection relation with another optical transmission apparatus opposite thereto, including:
an optical signal transmission unit provided on an input side of the optical switch configured to transmit an optical signal;
a transmission port control unit configured to control the optical switch;
a transmission unit configured to transmit a first control message including a transmission port number of a transmission port for transmitting the optical signal; and
a reception unit configured to receive a second control message including the transmission port number and a reception port number of a reception port of the opposite optical transmission apparatus for receiving the optical signal,
wherein
after the reception unit receives the second control message, the transmission port control unit controls the optical switch so that the optical signal is transmitted through a transmission port having a transmission port number next to the transmission port number included in the second control message.

30. An optical transmission apparatus having an optical switch capable of setting a connection relation with another optical, transmission apparatus opposite thereto, including:
a test signal transmission unit provided on an input side of the optical switch configured to transmit a test signal;
a transmission unit configured to transmit a control message including a transmission port number of a transmission port for transmitting the test signal,
wherein
the test signal transmission unit transmits the test signal through different transmission ports sequentially, separated by a predetermined time period.

31. An optical transmission apparatus having an optical switch capable of setting a connection relation with another optical transmission apparatus opposite thereto, including:
a test signal transmission unit provided on an input side of the optical switch configured to transmit a test signal;
a transmission unit configured to transmit a first control message including a transmission port number of a transmission port for transmitting the test signal; and
a reception unit configured to receive a second control message including the transmission port number and a reception port number of a reception port of the opposite optical transmission apparatus for receiving the test signal,
wherein
after the reception unit receives the second control message, the test signal transmission unit transmits the test signal through a transmission port having a transmission port number next to the transmission port number included in the second control message.
